(19) United States
(12) Patent Application Publication
(10) Pub. No.: US 2014/0236608 A1
(43) Pub. Date: Aug. 21, 2014

(54) SAMPLING OF MEDICAL DEVICES, AND APPLICATIONS THEREOF

(71) Applicants: Paul Richard Miklautsch, Cincinnati, OH (US); Micah Clayton Zender, Camp Dennison, OH (US)

(72) Inventors: Paul Richard Miklautsch, Cincinnati, OH (US); Micah Clayton Zender, Camp Dennison, OH (US)

(21) Appl. No.: 13/799,319

(22) Filed: Mar. 13, 2013

Related U.S. Application Data
(60) Provisional application No. 61/765,382, filed on Feb. 15, 2013.

(51) Int. Cl. G06Q 30/06; G06Q 50/22

(52) U.S. Cl. CPC G06Q 30/0631; G06Q 50/22
USPC 705/2

(57) ABSTRACT

Systems, methods, and computer storage mediums provide a medical device sample to a medical service provider. Embodiments of the present invention relate to equipping a computing device with the ability to automatically identify a need by a medical professional to use a medical device sample in a medical procedure. The computing device identifies the need of the medical professional for the medical device sample based on a medical procedure code that informs the computing device of the scheduled medical procedure and the requirements for executing the medical procedure. The computing device automatically searches medical device sample inventories that are supplied by medical device sample providers for a medical device sample that is available and satisfies the requirements for use in the medical procedure. The computing device automatically causes the medical device sample to be distributed to the medical professional for evaluation and use in the medical procedure.

The present application claims the filing benefit of U.S. Provisional Application Ser. No. 61/765,382, filed Feb. 15, 2013, the disclosure of which is incorporated herein by reference in its entirety.

### BACKGROUND OF THE INVENTION

To increase sales of medical devices, it is common for medical device manufacturers to provide sample medical devices to surgeons with the desire that surgeons will adopt the device for future surgical and/or other medical procedures. These devices are intended to increase the performance, care, and outcome in the execution of the surgical and/or medical procedure. To this end, the medical device manufacturer typically staffs sales representatives who build relationships with surgeons and hospitals to promote the manufacturer's medical products. One way sales representatives build these relationships is by providing samples of certain medical devices to surgeons so the surgeons may examine and/or evaluate the samples before committing to purchase the devices.

Sales representatives anticipate the medical device needs of surgeons based on communications with the surgeons. These communications may include in-person sales calls, phone calls, and/or e-mails to inquire regarding the needs of the surgeons. Sales representatives then locate samples that can be used by the surgeons and coordinate the delivery of those samples to the surgeons. Manufacturers are thus required to staff significantly large numbers of sales representatives so that the needs of surgeons for samples are continuously identified and satisfied. Failure to identify and/or satisfy a need of a surgeon for a sample may result in a lost sale of a medical device to the surgeon.

### SUMMARY OF THE INVENTION

The present invention overcomes the foregoing problems and other known shortcomings, drawbacks, and challenges of providing medical devices to surgeons by automatically identifying a need for a medical device sample by a surgeon and distributing the medical device sample to the surgeon for use in a medical procedure. While the present invention will be described in connection with certain embodiments, it will be understood that the present invention is not limited to these embodiments. To the contrary, the present invention includes all alternatives, modifications, and equivalents as may be included within the spirit and scope of the present invention

In one embodiment of the present invention, a computer implemented method provides a medical device sample to a medical professional. The medical procedure to be executed by the medical professional is identified based on a medical procedure code that provides requirements for execution of the medical procedure. At least one medical device sample inventory database is searched to identify a medical device sample that is suitable for execution of the medical procedure. The distribution of the identified medical device sample to the medical professional for use in executing the medical procedure identified by the medical procedure code may be arranged.

In another embodiment of the present invention, a system arranges for a medical professional to receive a medical device sample. An identification module is configured to identify the medical procedure to be executed by the medical professional based on a medical procedure code that provides requirements for execution of the medical procedure. A search module is configured to search at least one medical device sample inventory database to identify a medical device sample that is suitable for execution of the medical procedure. A distribution module is configured to arrange for the distribution of the identified medical device sample to the medical professional for use in executing the medical procedure identified by the medical procedure code.

In yet another embodiment of the present invention, a computer storage medium is encoded with a computer program, the program comprising instructions that, when executed by one or more processors, cause the one or more processors to perform operations to provide a medical device sample to a medical device service provider. A medical procedure to be executed by a medical professional may be identified based on a medical procedure code that provides requirements for execution of the medical procedure. At least one medical device sample inventory database may be searched for the medical device sample that is suitable for execution of the medical procedure. The distribution of the identified medical device sample to the medical professional for use in executing the medical procedure identified by the medical procedure code may be arranged.

In one embodiment of the present invention, a computer implemented method provides a medical device sample to a medical professional. The medical procedure to be executed by the medical professional is identified based on a medical procedure code that provides requirements for execution of the medical procedure. At least one medical device sample inventory database is searched to identify a medical device sample that is suitable for execution of the medical procedure. An individual may be notified that the medical device sample is identified as being suitable for execution of the medical procedure. The distribution of the identified medical device sample may be arranged to at least one of the individual and/or the medical professional for use by the medical professional in executing the medical procedure identified by the medical procedure code.

In another embodiment of the present invention, a system arranges for a medical professional to receive a medical device sample. An identification module is configured to identify the medical procedure to be executed by the medical professional based on a medical procedure code that provides requirements for execution of the medical procedure. A search module is configured to search at least one medical device sample inventory database to identify a medical device sample that is suitable for execution of the medical procedure. A notification module may notify an individual that the medical device sample is identified as being suitable for execution of the medical procedure. A distribution module is configured to arrange for the distribution of the identified medical device sample to at least one of the individual and/or the medical professional the medical professional for use by the medical professional in executing the medical procedure identified by the medical procedure code.

In yet another embodiment of the present invention, a computer storage medium is encoded with a computer program, the program comprising instructions that, when executed by one or more processors, cause the one or more processors to perform operations to provide a medical device sample to a medical device service provider. A medical procedure to be executed by a medical professional may be identified based on a medical procedure code that provides requirements for execution of the medical procedure. At least one medical device sample inventory database may be searched for the medical device sample that is suitable for execution of the medical procedure. An individual may be notified that the medical device sample is identified as being suitable for execution of the medical procedure. The distribution of the identified medical device sample may be arranged to at least one of the individual and/or the medical professional for use by the medical professional in executing the medical procedure identified by the medical procedure code may be arranged.

Further embodiments, features, and advantages, as well as the structure and operation of the various embodiments, are described in detail below with reference to the accompanying drawings.

### BRIEF DESCRIPTION OF THE DRAWINGS

Embodiments are described with reference to the accompanying drawings. In the drawings, like reference numbers may indicate identical or functionally similar elements.

FIG. 1 illustrates a network system in which embodiments of the present invention, or portions thereof, may be implemented;

FIG. 2 illustrates a medical device sampling configuration in which embodiments of the present invention, or portions thereof, can be implemented.

FIG. 3 is a flowchart showing an example method of automatic compatibility matching regarding a medical device sample with a medical professional;

FIG. 4 is a flowchart showing an example method of automatic event matching regarding a medical device sample with a medical professional;

FIG. 5 is a flowchart showing an example method of an on-demand request by a medical professional;

FIG. 6 is a flowchart showing an example method of an on-demand request by a procurement manager of a medical procedure provider;

FIG. 7 is a flowchart showing an example method of manual compatibility matching regarding a medical device sample with a medical professional;

FIG. 8 is a flowchart showing an example method of manual event matching regarding a medical device sample with a medical professional;

FIG. 9 is a flowchart showing an example method of semi-manual compatibility matching regarding a medical device sample with a medical professional;

FIG. 10 is a flowchart showing an example method of semi-manual compatibility matching regarding a medical device sample with a medical professional;

FIG. 11 is a flowchart showing an example method of providing a medical device sample; and

FIG. 12 illustrates an example computer system in which embodiments of the present invention, or portions thereof, may be implemented as computer-readable code.

### DETAILED DESCRIPTION OF THE INVENTION

The present invention generally relates to the field of medical device sampling. In an exemplary embodiment of the present invention, a digital sample sales computing device identifies a potential need of medical devices by a medical professional that has an upcoming medical procedure scheduled. The medical professional may require specific medical devices to adequately execute the upcoming medical procedure. The digital sample sales computing device determines an upcoming medical procedure and the medical devices required for the medical procedure via a medical procedure code, which is provided by a hospital information system. The hospital information system is operated by the hospital that the medical professional is associated with. The digital sample sales computing device searches medical device sample inventories. These sample inventories are each supplied by a medical device sample provider for medical device samples that are suitable for use in the medical procedure. A suitable medical device sample is located by the digital sample sales computing device, and the located device sample is distributed to the medical professional for use in the medical procedure.

In the Detailed Description herein, references to “one embodiment”, “an embodiment”, an “example embodiment”, etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment of the present invention, Applicants submit that it may be within the knowledge of one skilled in the art to effect such feature, structure, or characteristic in connection with other embodiments of the present invention whether or not explicitly described.

The following detailed description refers to the accompanying drawings that illustrate exemplary embodiments of the present invention. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the detailed description is not meant to limit the present invention to the embodiments described below.

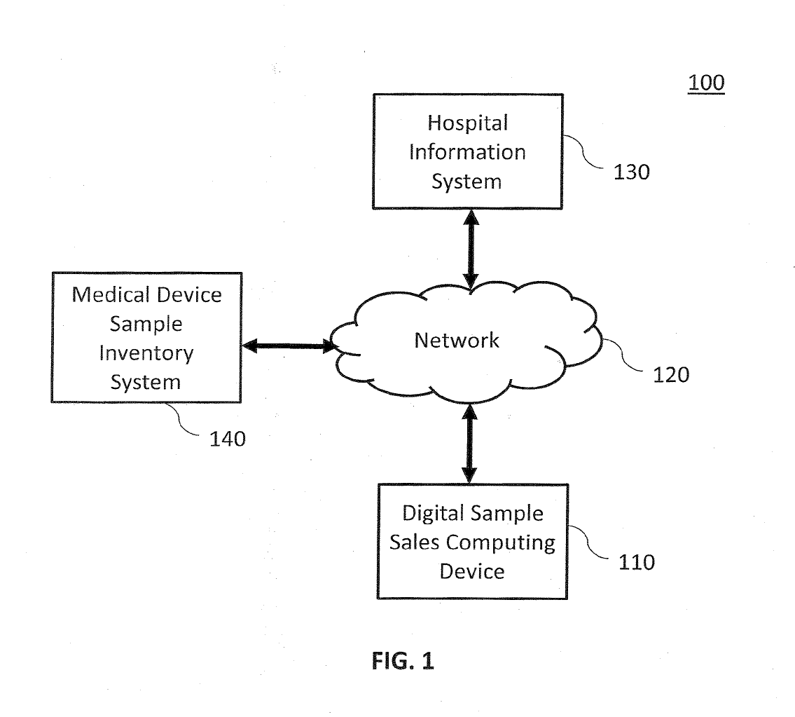

FIG. 1 illustrates a network system 100 in which embodiments of the present invention, or portions thereof, may be implemented. Network system 100 includes a digital sample sales computing device 110, a network 120, a hospital information system 130, and a medical device sample inventory system 140.

In one embodiment, one or more hospital information systems 130 and one or more medical device sample inventory systems 140 may connect to one or more digital sample sales computing devices 110 via the network 120. The hospital information system 130 may include a data information system, data management system, intranet, and/or software that interfaces with a hospital scheduling system, conventional web server, e-mail server, or file transfer server modified according to the one embodiment. The hospital information system 130 is typically a device that includes a processor, a memory, and a network interface, hereinafter referred to as a computing device or simply “computer”.

The medical device sample inventory system 140 may include a data information system, data management system, intranet, medical device manufacturing procurement system, conventional web server, e-mail server, or file transfer server modified according to the embodiments of the present invention. The medical device sample inventory system 140 may be a computing device.

The network 120 includes one or more networks, such as the Internet. In some embodiments of the present invention, the network 120 may include one or more wide area networks (WAN) or local area networks (LAN). The network 120 may utilize one or more network technologies such as Ethernet, Fast Ethernet, Gigabit Ethernet, virtual private network (VPN), remote VPN access, a variant of IEEE 802.11 standard such as Wi-Fi, and the like. Communication over the network 120 takes place using one or more network communication protocols including reliable streaming protocols such as transmission control protocol (TCP). These examples are illustrative and not intended to limit the present invention.

As referred to herein, the digital sample sales computing device 110 may be any type of processing (or computing device) as described above. For example, the digital sample sales computing device 110 may be a workstation, mobile device, computer, cluster of computers, set-top box, or other computing device. In an embodiment of the present invention, multiple modules may be implemented on the same computing device. Such a computing device may include software, firmware, hardware, or a combination thereof. Software may include one or more applications on an operating system. Hardware can include, but is not be limited to, a processor, memory, and/or graphical user interface display.

The digital sample sales computing device 110 may also include a conventional web server, e-mail server, or file transfer server configured to provide functions of the various embodiments of the present invention described herein. To this end, the digital sample sales computing device 110 may include software installed into an application layer associated with the hospital information system 130 and/or an application associated with the medical device sample inventory system 140. In another embodiment of the present invention, the digital sample sales computing device 110 may include hardware coupled to the hospital information system 130. This hardware may have access to hospital information system 130, but may maintain independent operational control from operators of the hospital information system 130. In another embodiment of the present invention, the digital sample sales computing device 110 may include hardware coupled to the medical device sample inventory system 140. This hardware may have access to medical device sample inventory system 140, but may maintain independent operational control from operators of medical device sample inventory system 140.

In a conventional approach, a medical device manufacturer provides medical devices to medical professionals for use in medical procedures executed by the medical professionals. The medical device manufacturer sells these medical devices to each hospital that the medical professionals are associated with so that each medical professional is able to use the medical devices sold to the hospital in executing medical procedures. To facilitate sales, the medical device manufacturer employs sales representatives to develop relationships with medical professionals and/or the hospitals associated with the medical professionals. The sale representatives thereby promote and/or sell medical devices manufactured by the medical device manufacturer. One step in this sales process is for the sales representatives to provide medical device samples for medical professionals to examine before they commit to purchase the actual medical devices.

A sales representative may anticipate opportunities to provide medical device samples to a medical professional based on the representative's relationship with the medical professional and/or the hospital associated with the medical professional. The sales representative thus remains in constant dialogue with the medical professional to anticipate when the medical professional may be performing a medical procedure that requires a medical device sample. The medical professional, in turn, relies on this interaction with the sales representative to receive medical device samples. However, a failure to anticipate when the medical professional may be performing a medical procedure that requires a medical device sample may result in a lost sale of the medical device.

In an embodiment of the present invention, the digital sample sales computing device 110 may receive and identify medical procedure codes provided by hospital information system 130. Each medical procedure code provides information regarding a scheduled medical procedure. The medical procedure code also provides a description of the medical procedure that has been scheduled, the medical professional assigned to perform the procedure, and the medical devices that are required to perform the scheduled medical procedure. The digital sample sales computing device 110 may then search the medical device sample inventory system 140 for a medical device sample supplied by a medical device manufacturer that is suitable for use in the scheduled medical procedure. The digital sample sales computing device 110 may then arrange for distribution of the suitable medical device sample to the medical professional. Thus, the digital sample sales computing device 110 eliminates the need for a sales representative to remain in constant dialogue with the medical professional to anticipate when the medical professional may require a medical device sample.

The digital samples computing device 110 may thereby increase the quantity of medical device samples provided to medical professionals in a shorter period of time as compared to the conventional sales representative approach. The digital samples computing device 110 may automatically identify each medical procedure that requires a medical device sample based on the medical procedure codes provided by hospital information system 130. This is in contrast to relying on the conventional approach of a sales representative to identify each medical procedure based on dialogues with the medical professionals.

Medical professionals and/or hospitals associated with medical professionals may benefit from the increased quantity of, and the increased speed with which medical device samples are provided by digital samples computing device 110. The increased quantity and promptness of medical samples may increase the likelihood of medical professionals coming into contact with modern medical device technology. This in turn may improve execution of medical procedures and result in improved patient care. These improvements in providing medical device samples may also allow medical professionals and/or hospitals associated with medical professionals to receive medical device samples from a broader spectrum of medical device manufacturers. This broader spectrum of medical device manufacturers may, in turn, enable medical professionals and/or hospitals to receive competitive pricing from several medical device manufacturers rather than relying on a single medical device manufacturer.

Medical device manufacturers may also benefit from the improvements in the distribution of medical device samples provided by the digital samples computing device 110. For example, using the digital samples computing device 110 to provide samples may result in faster adoption of actual medical devices by medical professionals. This in turn may increase the frequency of sales of the medical devices for the medical device manufacturers. The digital samples computing device 110 may also save sales representatives from spending additional man hours on medical device sampling, thus increasing efficiency by reducing the volume of man hours contributing to each actual medical device sale.

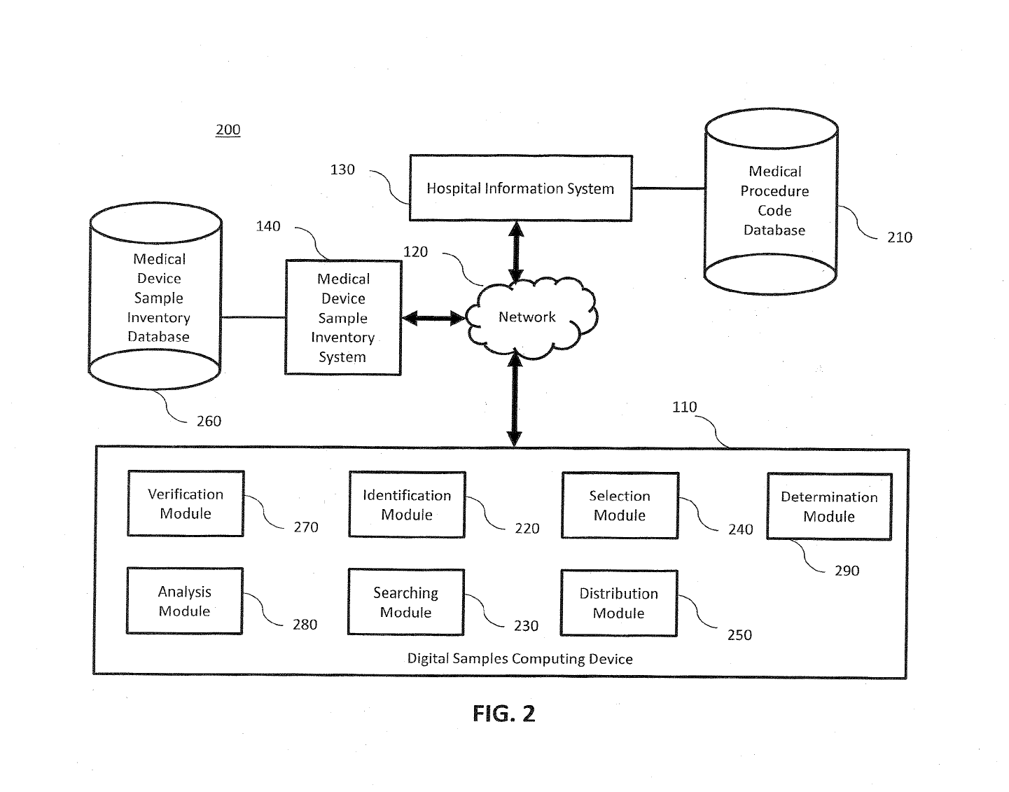

Referring now to FIG. 2, the network system 100 of FIG. 1 is shown in greater detail as an exemplary medical device sampling configuration or system 200 in which embodiments of the present invention, or portions thereof, may be implemented. The medical device sampling system 200 includes the digital samples computing device 110, the network 120, the hospital information system 130, the medical device sample inventory system 140, a medical procedure code database 210, and a medical device sample inventory database 260. The digital samples computing device 110 includes an identification module 220, a searching module 230, a selection module 240, a distribution module 250, a verification module 270, an analysis module 280, and a determination module 290.

As described above, the digital samples computing device 110 may identify a need for a medical device sample for a medical procedure, and arrange for the distribution of the medical device sample to the medical professional for use in a medical procedure. In an embodiment of the present invention, the identification module 220 may identify the medical procedure that is to be performed by the medical professional based on data obtained from the hospital identification system 130. The identification module 220 may identify the medical procedure based on a medical procedure code that is located in the medical procedure code database 210. The medical procedure code may provide requirements for executing the medical procedure. The searching module 230 may search the medical device sample inventory database 210 via the medical sample inventory system 140 to identify a medical device sample that is available and that satisfies the requirements of executing the medical procedure. The selection module 240 may select the identified medical device sample. The distribution module 250 may then distribute the selected medical device sample to the medical service provider for use by the medical professional in executing the medical procedure identified by the medical procedure code.

A medical device sample may include any sample of a medical device that may be used to treat a patient before, after, during the medical procedure, and/or any other phase of treatment of a patient. Those skilled in the relevant art will therefore understand that the medical device sample may be used for any aspect of the medical procedure, including treatment before and after the procedure, without departing from the spirit and scope of the present invention. A sample of a medical device is a medical device that is intended by a provider of the sample to be used by a medical professional for a trial period before the medical professional commits to purchasing an actual medical device from the provider. The medical device sample may include, but is not limited to, a catheter, sterile scissors, bandages, a knee brace, a computed axial tomography (CAT) scan device, a lap band placement tool, a stapler, a saw, a scalpel, an automated anesthesia drip and/or any other medical device sample suitable for treating a patient.

A medical professional may include an individual that is licensed to define, plan, execute, and/or perform any other licensed action that contributes to the completion of the medical procedure. A medical professional may include, but is not limited to, a licensed surgeon, podiatrist, neurological specialist, registered nurse, physical therapist, and/or any other medical professional that treats a patient. A medical procedure may include any procedure executed to treat a patient. A medical procedure may include, but is not limited, to preparing a patient for an invasive medical procedure, executing an invasive procedure, rehabilitating the patient following an invasive medical procedure, and/or any other medical procedure that treats a patient.

The digital samples computing device 110, hospital information system 130, and medical procedure code database 210 may share resources via network 120. For example, the digital samples computing device 110 may retrieve a medical device procedure code from the medical procedure code database 210. The hospital information system 130 may also ping the medical procedure code database 210 via the network 120 for medical procedure codes regarding additional medical procedures to be executed that may be matches for medical device samples. Based on the cloud computing configuration, the interaction between the digital samples computing device 110, the hospital information system 130 and the medical procedure code database 210 may not be limited to a single computing device. For example, a plurality of computing devices may update the medical procedure code database 210 via network 120 with medical procedure codes for additional scheduled medical procedures.

The digital samples computing device 110, medical device sample inventory system 140, and medical device sample inventory database 260 may also share resources via network 120. For example, the digital samples computing device 110 may retrieve medical device samples from the medical device sample inventory database 260. The medical device sample inventory system 140 may also update the medical device sample inventory database 260 with additional medical device samples that are available for execution of additional medical procedures. Based on the cloud computing configuration, the interaction between the digital samples computing device 110, the medical device sample inventory system 140, and the medical device sample inventory database 260 may not be limited to a single computing device. For example, a plurality of computing devices may update the medical device sample inventory database 260 via the network 120 with additional medical device samples that are available for execution of additional medical procedures.

Hospital information system 130 may be a data management system operated by a medical service provider to communicate with third party systems located within an infrastructure supported by the medical service provider. Hospital information system 130 may also enable the medical service provider to communicate with third party systems located outside of the infrastructure supported by the medical service provider. A medical service provider may include an entity with a geographical location where the patient receives the medical procedure executed by the medical professional. The medical service provider may include, but is not limited to, a hospital, an outpatient surgical office, an outpatient physical therapy clinic, a network of hospitals and outpatient offices, and/or any other type of medical service provider.

The hospital information system 130 pings the medical procedure code database 210 for a medical procedure code regarding each scheduled medical procedure for a medical service provider that may be a match for a medical device samples. Each medical procedure code includes requirements for execution for each scheduled medical procedure. For example, each medical procedure code may include a description of the medical procedure to be executed, identification of each medical professional scheduled to execute the medical procedure, each medical device required to perform the medical procedure, a location of where the medical procedure is scheduled to be executed, a support staff required for execution of the medical procedure, the recovery plan for the patient, the location where the patient will be recovering, a release plan of the patient and/or any other requirement necessary to execute the medical procedure.

Each medical procedure code may include a unique code that represents the medical procedure to be executed. For example, each medical procedure code may be issued based on an IDC-10 procedure coding system. IDC-10 is the American system of medical classification used for procedure codes. Each IDC-10 medical procedure code includes seven alphanumeric characters 0-9 and twenty-four letters A-H, J-N, and P-Z that may be used in each code. An example code may be 58150, which may represent a total abdominal hysterectomy with or without the removal of tubes and/or with or without the removal of ovaries.

The hospital information system 130 may ping the medical procedure code database 210 for medical procedure codes of scheduled medical procedures via a scheduling system. In response, the scheduling system may schedule upcoming medical procedures. The hospital information system 130 may then ping the medical procedure code database 210 for medical procedure codes of scheduled medical procedures based on the medical procedures that are entered into the scheduling system.

An example of the hospital information system 130 pinging the medical procedure code database 210 for a medical procedure code is as follows. A patient is provided with an initial diagnosis that they require an abdominal hysterectomy procedure. The scheduling system schedules the patient for the abdominal hysterectomy procedure to be performed by a particular surgeon at a particular hospital on a particular date. In response, the hospital information system 130 pings the medical procedure code database 210 for the abdominal hysterectomy procedure with a medical procedure code of 58150. The hospital information system 130 defines that the abdominal hysterectomy procedure is scheduled to be performed on the patient at the hospital by the surgeon and each medical device required for execution of the abdominal hysterectomy procedure. The medical procedure code 58150 provides this information when referenced.

The identification module 220 may identify a scheduled medical procedure to be executed by a medical professional based on a medical procedure code included in the medical procedure code database 210. The identification module 220 may query the medical procedure code database 210 for medical procedure codes for scheduled medical procedures. The identification module 220 may then identify the medical devices required for execution of the scheduled medical procedure based on the medical devices defined by the medical procedure code.

In an embodiment of the present invention, the identification module 220 may query the medical procedure code database 210 for new medical procedure codes that identify recently scheduled medical procedures which have been entered into medical procedure code database 210. New medical procedure codes may be codes entered since the previous query by identification module 220. In another embodiment of the present invention, the identification module 220 may continuously query the medical procedure database 210 for new medical procedure codes that identify recently scheduled medical procedures that have been entered into the medical procedure code database 210. In yet another embodiment of the present invention, the hospital information system 130 may notify the identification module 220 when the hospital information system 130 has pinged the medical procedure code database 210 for additional medical procedure codes. In such an embodiment, the identification module 220 may then identify the additional medical procedure codes entered into medical procedure code database 210. The identification module 220 may also query the medical procedure code database 210 for column headers and/or row types included in the medical procedure code database for medical procedure codes. The medical procedure codes in which identification module 220 queries medical procedure code database for column headers and/or row types may also be pre-defined material procedure codes. The identification module 220 may also tap into an outbound database field included in medical procedure code database 210 to query medical procedure code database 210.

The searching module 230 may identify the medical devices included in the medical procedure code identified by identification module 220 for a scheduled medical procedure. The searching module 230 may search the medical device sample inventory database 260 for a medical device sample that is: (1) available for use in the scheduled medical procedure, and (2) a suitable replacement for the medical device included in the medical procedure code provided by the medical device sample inventory system 140.

The searching module 230 determines whether a medical device sample available in medical device sample inventory database 260 is a suitable replacement for the medical device included in the medical procedure code. Searching module 230 may examine information included in a kit associated with the medical device sample to determine whether the medical device sample is a suitable replacement for the medical device included in the medical procedure code. The kit associated with the medical device sample may describe the inclusion of materials regarding the medical device sample, documents regarding the medical device sample, objects included in the medical device sample, and/or any other suitable information.

The searching module 230 may determine whether the medical device sample is certified for use on a human. A medical device sample that is certified for use on a human may be used in the medical procedure to be performed on the patient. The searching module 230 may also determine whether the medical device sample is not certified to be used on a human. A medical device sample that is not certified for use on a human may physically represent the actual medical device to be used in the medical procedure, but that lacks the functionally of the actual medical device so that it cannot be used in the medical procedure. A medical device sample that is not certified for use on humans may be sampled by the medical professional so that the medical professional may become familiar with the medical device sample before the medical procedure. An actual medical device to be used in the medical procedure may then be delivered to the medical professional for use in the scheduled medical procedure.

For example, the medical device procedure code may include a scalpel that is required for execution of the scheduled abdominal hysterectomy procedure. The searching module 230 will then search the medical device sample inventory database 260 via medical device sample inventory system 140 for a scalpel that is both available and a suitable replacement for the scalpel required for the abdominal hysterectomy procedure. The searching module 230 examines the kit associated with the scalpel, and determines that the scalpel is not suitable for human use in that the scalpel is a representation of the actual scalpel to be used in the abdominal hysterectomy procedure. The searching module 230 identifies the scalpel as an available medical device sample that can be used by the medical professional to become familiar with the device before executing the abdominal hysterectomy procedure. The medical professional may then receive an actual scalpel to be used to execute the abdominal hysterectomy procedure when the medical professional determines that they are satisfied with the scalpel sample.

Medical device sample inventory system 140 updates medical device sample inventory database 260 with medical device samples available for use in medical procedures as the medical device samples become available. Medical device sample inventory database 260 may include medical device samples available for use in medical procedures from a medical device supplier. Medical device inventory sample system 140 and/or medical device sample inventory database 260 may be supported by a medical device manufacturer, a medical device distribution center, a temporary sample supplier and/or any other type of medical device supplier that will be apparent to those skilled in the relevant art(s) without departing from the spirit and scope of the disclosure.

A medical device manufacturer may include any entity that produces medical devices for patient care. A medical device distribution center may include any central depository for medical devices that may be received and/or shipped. A medical device distribution center may be supplied with medical devices from other medical device manufacturers for distribution to medical service providers. A medical device distribution center may include a warehouse, a shipping facility, and/or any other type of distribution center, such as would be apparent to those skilled in the relevant art without departing from the spirit and scope of the disclosure. A temporary sample supplier may include a sampling company that temporarily engages the medical device manufacturer to act as a temporary supplier of medical device samples. After the conclusion of a sampling campaign, the temporary sample supplier is no longer engaged with the medical device manufacturer, and no longer supplies medical device samples for the medical device manufacturer.

The selection module 240 may select the medical device sample identified by the searching module 230 from the medical device sample inventory database 260 via the medical device sample inventory system 140. The selection module 240 may select the medical device sample from medical device sample inventory database 260 that has been identified by searching module 230 as being available and being a suitable replacement for the medical device included in the medical device procedure code. The medical device sample selected by selection module 240 may then be committed for use in the scheduled medical procedure. As a result, the selected medical device sample is no longer available for use in other scheduled medical procedures. Accordingly, the medical device sample inventory system 140 may update medical device sample inventory database 260 to no longer include the medical device sample selected by selection module 240 because the selected medical device is no longer available. Updating the medical device sample inventory database 260 enables the searching module 230 to continue to accurately identify medical device samples that are available for use in scheduled medical procedures.

The distribution module 250 may distribute the medical device sample selected by the selection module 240 to the medical service provider. The medical device sample is thereby made available for use by the medical professional in executing the medical procedure associated with the medical procedure code, which was identified by identification module 220. The distribution module 250 may distribute the medical device sample from a location where the medical device sample is stored to the location of the medical service provider where the medical procedure is to be executed. Distribution module 250 may determine where the medical device sample is located based on location information provided by medical device sample inventory database 260. The medical device sample inventory system 140 may update the medical device sample inventory database 260 with an updated location of the medical device sample when the medical device sample is transferred to a different location.

The distribution module 250 may distribute the medical device sample from the medical device manufacturer, the distribution center, the temporary medical device sample supplier, and/or any other location that houses medical device samples. In an embodiment of the present invention, distribution module 250 may distribute the medical device sample directly from the medical device manufacturer to the medical service provider. If the medical device sample selected by the selection module 240 is an expensive medical device sample, the medical device manufacturer may not be able to locate a distribution center and/or a temporary medical device sample supplier to accept the risk of handling the expensive medical device sample. In this case, the medical device manufacturer may store the medical device sample until the distribution module 250 distributes the medical device sample to the medical service provider.

In another embodiment of the present invention, the distribution module 250 may distribute the medical device sample from the distribution center. In this embodiment, the medical device manufacturer may transfer the medical device sample to an independent distribution center to store the medical device sample. Depending on the nature of the device, the independent distribution center may include a sterile environment and/or be certified to store the medical device sample. Transferring the medical device sample by medical device manufacturer to the independent distribution center may reduce the costs for the medical device manufacturer in storing the medical device sample. Thus, the independent distribution center may store the medical device sample until the distribution module 250 distributes the medical device sample to the medical service provider.

In yet another embodiment of the present invention, the distribution module 250 may distribute the medical device sample from the temporary medical device sample supplier. In this embodiment, the medical device manufacturer may temporarily engage the temporary medical device sample supplier to supply a large quantity of a specific medical device during a sampling campaign conducted by the medical device manufacturer. The sampling campaign may be used by the medical device manufacturer to leverage and/or promote specific benefits of a medical device. After the sampling campaign has been concluded, the engagement between the temporary medical device sample supplier and the medical device manufacturer may be terminated. Thus, the temporary medical device sample supplier may store the medical device sample until distribution module 250 distributes the medical device sample to the medical service provider.

By way of example, the medical device manufacturer may conduct a sampling campaign for scalpels. To this end, the medical device manufacturer may engage the temporary medical device sample supplier to supply a large quantity of scalpels to medical professionals until the sampling campaign is terminated. The medical device manufacturer terminates the engagement with the temporary medical device sample supplier at the end of the sampling campaign so that the temporary medical device sample supplier no longer supplies scalpels after the sampling campaign has ended.

In an embodiment, the distribution module 250 may arrange for distribution of the medical device sample directly to the medical professional. Alternatively, the distribution module 250 may distribute the medical device sample indirectly to the medical professional via to the medical service provider, a location in which the medical procedure is to be executed, the office of the medical professional, the home of the medical professional, a post office box for the medical professional, a post office box for the medical service provider, a warehouse operated by the medical service provider, to an insurance company that is insuring the medical procedure, a sales representative for the medical device manufacturer and/or any other direct or indirect distribution to the medical professional, such as would be apparent to those skilled in the relevant art without departing from the spirit and scope of the disclosure.

In an embodiment, the distribution of the medical device sample may be manually distributed to the medical professional via an individual, such as a sales representative of the medical device manufacturer. Digital samples computing device 110 may notify the sales representative that a medical device sample has been matched with a scheduled medical procedure. Distribution module 250 may distribute the medical device sample to the sales representative. The sales representative may then manually deliver the medical device sample to the medical professional for use in the medical procedure.

The verification module 270 may verify that the medical professional scheduled to execute the medical procedure is qualified to use the medical device sample selected by selection module 240 to execute the medical procedure. Verification module 270 may also verify that the medical service provider where the medical procedure is scheduled to take place is also qualified to use the medical device sample selected by selection module 240 in executing the medical procedure.

The distribution module 250 may distribute the medical device sample to the medical service provider for use by the medical professional in executing the medical procedure when verification module 270 successfully verifies that medical service provider and/or the medical professional are qualified to use the medical device sample. The distribution module 250 may refrain from distributing the medical device sample to the medical device service provider for use by the medical professional in executing the medical procedure when the verification module 270 fails to verify that the medical service provider and/or the medical professional is qualified to use the medical device sample.

As noted above, the medical procedure code for the scheduled medical procedure identifies each medical professional that is scheduled to participate in the medical procedure along with each medical device sample to be used in executing the medical procedure. Verification module 270 may verify whether the medical professional identified by the medical procedure code is certified to use the medical device sample in execution of the medical procedure.

In an embodiment of the present invention, the hospital information system 130 may store each certification license for each medical professional in a personnel system. The personnel system may be a database that stores each certification license for each respective medical professional. The verification module 270 may retrieve each certification license for the medical professional from the personnel system to verify whether the medical professional is certified to use the medical device sample in execution of the medical procedure. Verification module 270 may also verify that the hospital information system 130 has stored any medical board license, medical device operation certification, and/or any other type of require certification. Verification module 270 may also verify whether the medical service provider is also certified to use the medical device sample in a substantially similar manner as described above with regard to verifying the medical device professional.

For example, the selection module 240 may select an automated anesthesia drip to distribute as a medical device sample to the hospital where the abdominal hysterectomy procedure is scheduled to take place. The verification module 270 searches the personnel system included in the hospital information system 130 for any certifications for the medical professional listed as the anesthesiologist in the corresponding medical procedure code. If the verification module 270 identifies a medical board license for the anesthesiologist, the verification module 270 successfully verifies that the anesthesiologist is a board certified anesthesiologist that is qualified to operate the automated anesthesia drip. In response to the verification module 270 verifying the anesthesiologist is board certified, the distribution module 250 distributes the automated anesthesia drip to the anesthesiologist.

By way of another example, selection module 240 may select the automated anesthesia drip to distribute as a medical device sample to an outpatient clinic where the patient is scheduled to rehabilitate from the abdominal hysterectomy procedure. In response, the verification module 270 searches the hospital information system 130 for any certifications that the outpatient clinic may have. If the verification module 270 fails to locate any certifications for the outpatient clinic to administer anesthesia, the verification module 270 will fail to verify that the outpatient clinic listed in the medical procedure code is licensed to have the automated anesthesia drip. This failure may indicate that the outpatient clinic is not equipped and/or does not have a need for the automated anesthesia drip. This may occur, for example, if the medical procedure code incorrectly listed the outpatient clinic as a location for the automated anesthesia drip. In response to the verification module 270 failing to verify the outpatient clinic, the distribution module 250 will refrain from distributing the automated anesthesia drip to the outpatient clinic.

The analysis module 280 may analyze retention of the medical device sample by the medical professional for additional medical procedures following usage of the medical device sample in execution of the medical procedure. After the medical professional uses the medical device sample, the medical professional may: (1) continue to use the medical device sample, (2) decide to purchase an actual medical device from the medical device manufacturer as a result of the medical device sample, (3) reject the medical device sample, (4) refuse to purchase the actual medical device, and/or (5) perform some other suitable action in response to using the medical device sample. The analysis module 280 may then analyze how the medical professional responds following the use of the medical device sample.

The analysis module 280 may then determine the conversion rate of medical device samples. The conversion rate of medical device samples is the quantity of medical device samples that are converted into actual medical devices (i.e., that are sold to the medical professional or treatment facility). The medical professionals convert the medical device samples into actual medical devices by purchasing the actual medical devices from the medical device manufacturer after a positive experience with the medical device samples. The conversion rate provided by the analysis module 280 provides the medical device manufacturer with a metric of sales that were generated by providing the medical device samples.

The analysis module 280 may also provide data regarding the retention rate for the medical device samples. In some cases, the medical device sample may be retained by the medical professional after execution of the medical professional. The analysis module 280 may monitor medical device retention so that the medical device manufacturer may be put on notice when a specific medical device sample may be retained by several medical professionals that are associated with the medical service provider. The medical device manufacturer may then approach the medical service provider to negotiate whether the medical service provider would like to purchase actual medical devices from the medical device manufacturer based on the retention of the medical device samples.

A low conversion rate and/or a low medical device retention data for medical device samples may put the medical device manufacturer on notice that the medical device samples were not well received by the medical professionals. The medical device manufacturer may then determine to stop providing those medical device samples in the future, and/or re-evaluate the value of the product line represented by the medical device samples.

In an embodiment of the present invention, the analysis module 280 may analyze an inventory system that is included in hospital information system 130 to determine whether the medical professional has continued to use the medical device sample. The inventory system included in the hospital system 130 maintains a running list of all medical devices currently available to medical professionals practicing at the medical service provider location. The hospital information system 130 may regularly update the inventory system with the medical devices currently available. The analysis module 280 may search the inventory system via the hospital system 130 following the execution of the medical procedure to determine whether the medical professional who executed the medical procedure has kept the medical device sample in stock. The analysis module 280 may thereby provide medical device retention data for the medical device sample to the medical device manufacturer. The medical device manufacturer may thereby determine how to respond regarding the medical device sample based on the retention data.

In an embodiment of the present invention, the analysis module 280 may analyze the frequency with which a procurement manager for the medical service provider purchased actual medical devices from the medical device manufacturer based on the use of the medical device sample. The procurement manager may be the decision maker regarding purchasing decisions for medical devices for the medical service provider. The procurement manager may respond to requests from the medical professionals to purchase actual medical devices from the medical device manufacturer based on the positive experiences that the medical professionals had with the medical device samples. The procurement manager may also mandate which medical devices are permissible for the medical professionals to use. In this embodiment, the analysis module 280 may analyze the frequency in which the procurement manager purchased actual medical devices via the hospital information system 130. The analysis module 280 may then provide the conversion rate for the medical device sample to the medical device manufacturer so that the medical device manufacturer can determine how to respond with regard to the medical device sample in question.

In an embodiment of the present invention, the medical professional may update their preference card for the medical procedure with a preference to use an actual medical device in future medical procedures based on the use of the medical device sample in a previous medical procedure. The medical professional may update a preference card for each type of medical procedure they perform to indicate the types of medical devices that the medical professional prefers for execution of the procedure. The hospital information system 130 may be provided with these updated preference cards so that the inventory system may be stocked with the medical devices represented on the preference card for the medical professional to use in future medical procedures.

The analysis module 280 may track the update to the inventory system provided by the updated preference card to determine that the medical professional now prefers the medical device represented by the medical device sample based on their experience with the medical device sample. In response, the medical device manufacturer may reach out to the procurement manager of the medical service provider to negotiate a sale of the actual medical devices now preferred by the medical professional. The analysis module 280 may also track the inventory system to determine that the medical professional had not updated his/her preference card following execution of the medical procedure. In this case, medical device manufacturer may decline to provide additional medical device samples to the medical professional based on the lack of an update to the preference card. The analysis module 280 may also include tracking tools that gather and report the data gathered based on the tracking tools, and a dashboard to visually view the analysis of the data gathered.

The determination module 290 may determine whether medical device samples that are substantially equivalent to the medical device sample selected by selection module 240 have been previously distributed to the medical service provider associated with the medical professional by distribution module 250. Distribution module 250 may distribute the medical device sample in response to the determination module 290 determining that the medical service provider does not already have an adequate inventory of medical device samples. On the other hand, the distribution module 250 may refrain from distributing the medical device sample in response to the determination module 290 determining that the medical service provider already has an adequate inventory of medical device samples.

Distribution module 250 may refrain from distributing the medical device selected by selection module 240 when substantially equivalent medical device samples have previously been distributed by distribution module 250 to the medical service provider. This may support a desire by the medical device manufacturer to avoid distributing additional medical samples to the medical service provider when the medical service provider already has an adequate quantity of medical device samples. Each medical device sample distributed by distribution module 250 may be an additional cost for the medical device manufacturer. The medical device manufacturer may therefore determine that the distribution of additional medical device samples to the medical service provider is not worth the additional cost. Thus the determination module 290 may ensure that the medical device manufacturer refrains from oversampling the medical service provider with the medical device sample.

In an embodiment of the present invention, determination module 290 may determine whether a particular type of medical device sample has been distributed by the distribution module 250 to the medical service provider in an amount that exceeds a threshold. The determination module 290 may establish a threshold for each type of medical device sample. This threshold may be a quantity of medical devices for a medical device type that have already been distributed by distribution module 250 and/or are still available in the inventory system as updated by hospital information system 130. Distributing additional medical device samples to the medical service provider beyond the threshold may not be worth the additional cost to the medical device manufacturer. On the other hand, distributing additional medical device samples to the medical service provider when below the threshold may be worth the additional cost to the medical device manufacturer.

The determination module 290 may determine whether the threshold for the type of medical device sample has been exceeded (as represented in the inventory system of hospital information system 130) before authorizing distribution module 250 to distribute an additional medical device sample. The determination module 290 may authorize the distribution module 250 to distribute the additional medical device sample when determination module 290 determines that the threshold for that type of medical device sample represented in the inventory system has not been exceeded. In contrast, the determination module 290 may not authorize the distribution module 250 to distribute the additional medical device sample in response to the determination module 290 determining the threshold for that type of medical device sample, as represented in the inventory system, has been exceeded.

Returning to the previous example, the selection module 240 may select a scalpel for the abdominal hysterectomy to be executed by the medical professional. The determination module 290 queries the inventory system included in hospital information system 130 to determine the quantity of scalpels presently located at the hospital where the abdominal hysterectomy is to be executed. The determination module 290 may determine that twenty-five scalpels are present at the hospital based on the quantity reported by the inventory system. The determination module 290 may then determine that the threshold of scalpels is twenty. Thus the threshold of scalpels present at the hospital has been exceeded. In response to this determination, the determination module 290 may refrain from distributing additional scalpels to the hospital.

In an embodiment of the present invention, the determination module 290 may determine whether the threshold has been exceeded based on periodic checks of the quantity of the type of medical device sample represented by the inventory system, the volume of the type of medical device sample present represented by the inventory system, the volume in which distribution module 290 may have distributed that type of medical device sample, and/or any other type of threshold that will be apparent to those skilled in the relevant art without departing from the spirit and scope of the disclosure.

In another embodiment of the present invention, the determination module 290 may determine whether the threshold of medical device samples sent to the medical service provider has been exceeded based on a sampling formula. The determination module 290 may estimate an average number (U) of medical device samples that are to be used by the medical professional at any medical service provider associated with the medical professional. This estimate may be provided by the medical device manufacturer. The determination module 290 may also estimate an average number (V) of surgeons that may perform the medical procedure per medical service provider. This estimate may also be provided by the medical device manufacturer. The determination module 290 may also determine: (1) a quantity (W) of specific medical procedures that may be performed at the medical service provider per month, (2) a quantity (X) of medical professionals that are compliant to use the medical device sample at the medical service provider, (3) a quantity (Y) of medical device samples provided by competitors of the medical device manufacturer that are used per month at the medical service provider, and (4) a quantity (Z) of medical device samples provided by competitors that are remaining in the inventory system for the medical service provider. The determination module 290 may authorize distribution module 250 to distribute additional samples to the medical service provider based on these quantities. For example, the determination module 290 may authorize distribution of additional samples when UN is ≧to W/X.

By way of an example, a 100 medical device samples may be sampled per month on average at the hospital, and an average of 4 surgeons may perform surgeries at the hospital. With 100 available medical device samples and 4 surgeons, an average of 25 medical device samples are used by each of the 4 surgeons. If a hospital is identified with surgeons that have a use of medical device samples that exceeds 25, the amount of medical device samples at the hospital may not be sufficient to satisfy the need of each surgeon. The determination module 290 may then determine whether to authorize distribution module 250 to distribute additional samples to the hospital because the existing amount of medical device samples located at the hospital is insufficient.

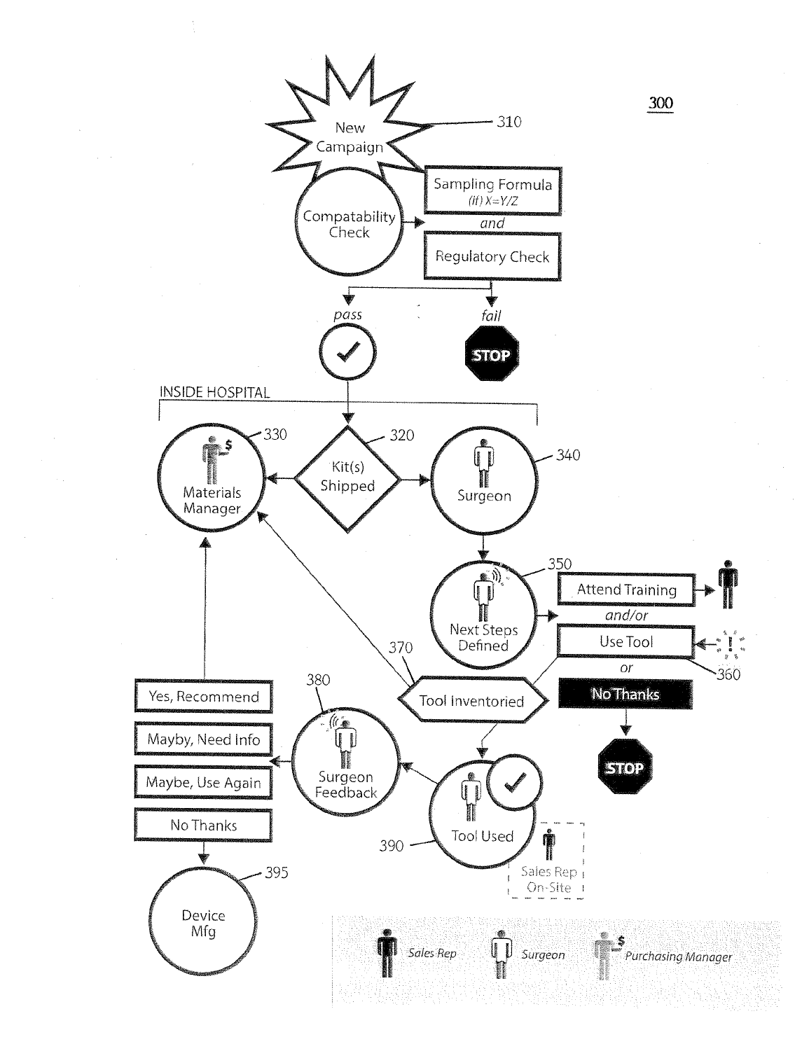

Referring now to FIG. 3, a flowchart is presented showing an exemplary process 300 for automatic compatibility matching between a medical device sample and a medical professional that may be executed by elements of system 200. As shown in FIG. 3, process 300 begins at step 310 and in response to a medical device manufacturer initiating a medical device sampling campaign. At step 310 of process 300, the medical device may be added to the digital samples computing device 110 for indexing before proceeding to step 320 of process 300.

At step 320 of process 300, the digital samples computing device 110 automatically sends the medical device sample to the medical professional based upon a regulatory compliance check performed by the verification module 270. The medical device sample may be sent as a kit that includes multiple items such as, but not limited to, instructions for use of medical device sample, training materials for the medical device sample and/or other documents. From step 320, the system 200 may proceed to execute steps 330 and/or 340 of process 300.

At step 330 of process 300, the digital samples computing device 110 may automatically send a kit to the hospital procurement manager that includes various sales and/or marketing materials, and a document informing the hospital procurement manager that the medical professional is evaluating the new medical device sample.

At step 340 of process 300, the digital samples computing device 110 may send communication to the medical professional through a means such as but not limited to a text message, e-mail message, voice message, web message and/or application message to define the next steps regarding the medical device sample. In response to sending the communication, the system 200 may proceed to step 350 of process 300.

At step 350 of process 300, the digital samples computing device 110 may define the next steps to be taken regarding the medical device sample with the medical professional. The next steps may include, but are not limited to, determining whether the medical professional desires to attend training with the medical device sample in a simulated lab environment, to use the medical device sample in an upcoming medical procedure on a patient, and/or decline the next steps because the medical professional is not interested in the medical device sample. In response to the medical professional indicating a desire to use the medical device, the system 200 may proceed to step 360 of process 300.

At step 360 of process 300, the digital sample computing device 110 acts upon the response provided by the medical professional indicating that the medical professional desires use the medical device sample in the upcoming medical procedure. In response, the distribution module 250 may send the for human use medical device sample to the medical service provider to be inventoried for an upcoming medical procedure. The system 200 may then proceed to step 370 of process 300.

At step 370 of process 300, the digital samples computing device 110 may send a notification to the medical professional and/or the medical service provider indicating that the medical device sample has been inventoried by the medical service provider for use in the upcoming medical procedure scheduled for a specific date.

At step 390 of process 300, the medical device sample is used to perform the procedure. In response, system 200 may proceed to step 380 of process 300. At step 380 of process 300, the digital samples computing device 110 may communicate to the medical service provider that the medical device sample was utilized and reviewed by the medical professional and has received feedback from the medical professional regarding the medical device sample. The digital samples computing device 110 may also communicate with the medical professional after the medical device sample has been used in the medical procedure to determine how the medical professional would like to proceed regarding the medical sampling device.

To this end, the medical professional may select from, but is not limited to, the following choices: (1) recommend that the medical device manufacturer bring the medical device sample to the hospital committee for approval and/or to engage in contract negotiations with the medical device manufacturer; (2) request additional information regarding the medical device sample from the medical device manufacturer; (3) voice that the medical professional would use the medical device if the medical device were available at the medical service provider, but would not request that the medical service provider obtain the medical device; or (4) voice that the medical professional would not use the medical device sample again because the medical device sample did not perform up to the expectations of the medical professional and that the medical professional prefers the existing medical device that the medical professional uses. The system 200 may then proceed to step 395 of process 300.

At step 395 of process 300, the digital samples computing device 110 may communicate back to the medical device manufacturer and/or the hospital procurement manager that the medical device sample was utilized in the medical procedure and reviewed by the medical professional and has received feedback from the medical professional regarding the medical device sample.

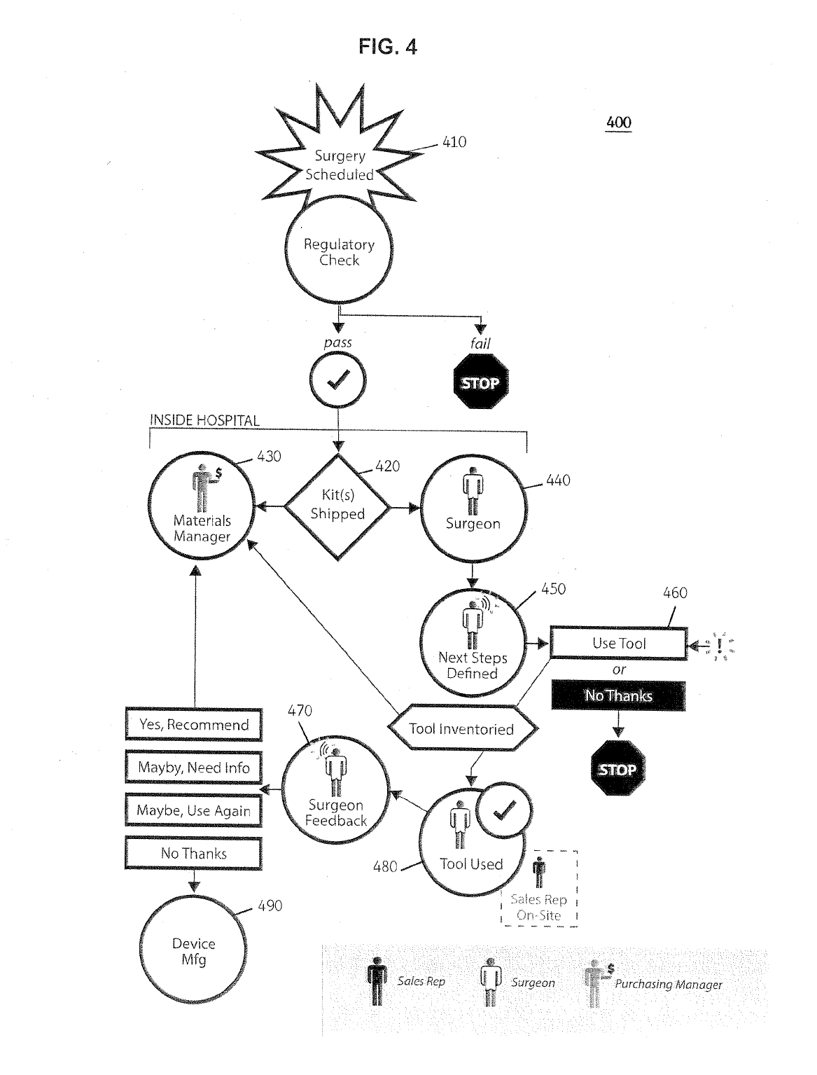

Referring now to FIG. 4, a flowchart is presented showing an exemplary process 400 for automatic event matching between a medical device sample and a medical professional that may be executed by the elements of system 200. As shown in FIG. 4, process 400 begins at step 410. At step 410, and in response to a new medical procedure code being published in the medical procedure code database 210 by the hospital information system 130, the system 200 performs a regulatory check. In the present example, the medical procedure code is an ICD-10 procedure code that matches a currently active medical device sampling campaign. The system 200 may then proceed to step 420 of process 400.

At step 420 of process 400, the digital samples computing device 110 automatically sends the medical device sample to the medical professional based upon a regulatory compliance check performed by verification module 270. The medical device sample may be sent as a kit that includes multiple items such as but not limited to instructions for use of medical device sample, training materials for the medical device sample and/or other documents. The system 200 may then proceed to steps 430 and 440 of process 400

At step 430 of process 400, the digital samples computing device 110 may automatically send a kit to the hospital procurement manager that includes various sales and/or marketing material and a document informing the hospital procurement manager that the medical professional is evaluating the new medical device sample.

At step 440 of process 400, digital samples computing device 110 may send communication to the medical professional through a means such as, but not limited to, a text message, e-mail message, voice message, web message and/or application message to define the next steps regarding the medical device sample. The system 200 may then proceed to step 450 of process 400.

At step 450 of process 400, the digital samples computing device 110 may define the next steps to be taken regarding the medical device sample with the medical professional. The next steps may include, but are not limited to, the medical professional using of the medical device sample in an upcoming medical procedure on a patient, and/or declining to use the sample device sample because the medical professional is not interested in the medical device sample. The system may then proceed to step 460 of process 400.

At step 460 of process 400, the digital sample computing device 110 acts upon the response provided by the medical professional in which the medical professional desires to use the medical device sample in the upcoming medical procedure. In response to the medical professional indicating a desire to use the medical device sample, the distribution module 250 may send the medical device sample to the medical service provider to be inventoried for an upcoming medical procedure. The system 200 may then proceed to step 480 of process 400.

At step 480 of process 400, the digital samples computing device 110 may communicate to the medical service provider that the medical device sample was utilized and reviewed by the medical professional, and that feedback has been received from the medical professional regarding the medical device sample. The system 200 may then proceed to step 470 of process 400.

At step 470 of process 400, the digital samples computing device 110 may communicate with the medical professional after the medical device sample has been used in the medical procedure to determine how the medical professional would like to proceed regarding the medical sampling device. The medical professional may proceed may choose from, but is not limited to, the following responses: (1) recommend that the medical device manufacturer bring the medical device sample to the hospital committee for approval and/or to engage in contract negotiations with the medical device manufacturer; (2) request additional information regarding the medical device sample from the medical device manufacturer; (3) voice that the medical professional would use the medical device if the medical device were available at the medical service provider but would not request that the medical service provider obtain the medical device; or (4) voice that the medical professional would not use the medical device sample again because the medical device sample did not perform up to the expectations of the medical professional and that the medical professional prefers the existing medical device that the medical professional uses. In response to receiving the feedback from the medical professional, the system 200 may proceed to step 490 of process 400.

At step 490, digital samples computing device 110 may communicate back to the medical device manufacturer and/or the hospital procurement manager that the medical device sample was utilized in the medical procedure and reviewed by the medical professional and has received feedback from the medical professional regarding the medical device sample.

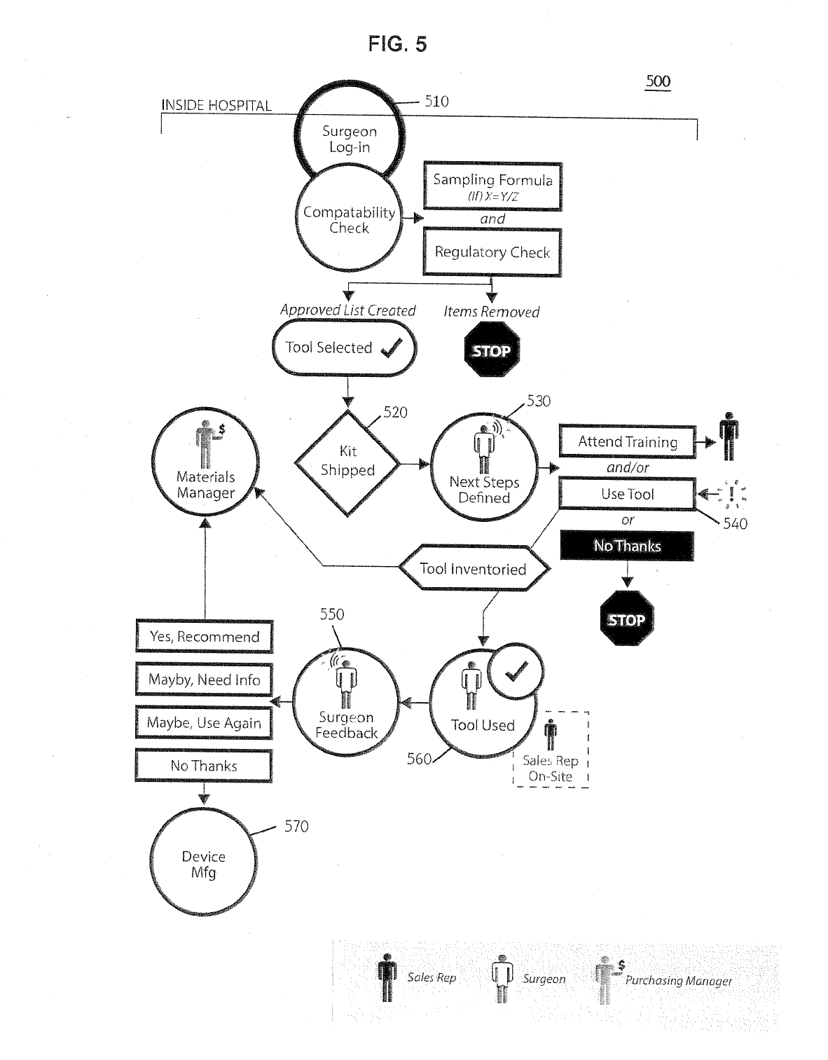

Referring now to FIG. 5, a flowchart is presented showing an example process 500 for an on-demand request by a medical professional that may be executed by the elements of system 200. As shown in FIG. 5, process 500 begins at step 510, in response to the medical professional logging into the medical device sample viewer included in the digital samples computing device 110 and locating a device that the medical professional would like to sample. The system 200 may then proceed to step 520 of process 500.

At step 520 of process 500, the digital samples computing device 110 automatically sends the medical device sample to the medical professional contingent upon the results of a regulatory compliance check performed by verification module 270. The medical device sample may be sent as a kit that includes multiple items such as but not limited to instructions for use of medical device sample, training materials for the medical device sample and/or other documents. In response to sending out the kits, the system 200 may proceed to step 530 of process 500.

At step 530 of process 500, the digital samples computing device 110 may send a communication to the medical professional through any suitable means, such as but not limited to a text message, e-mail message, voice message, web message and/or application message to define the next steps regarding the medical device sample. The digital samples computing device 110 may define the next steps to be made available to the medical professional regarding the medical device sample with the medical professional. The next steps may include, but are not limited to, attending training for the medical device sample in a simulated lab environment, using the medical device sample in an upcoming medical procedure on a patient, and/or declining the next steps because the medical professional is not interested in the medical device sample. In response to the medical professional choosing one of the next steps, the system 200 may proceed to step 540 of process 500.

At step 540 of process 500, the digital sample computing device 110 acts upon the response provided by the medical professional in which the medical professional desires to use the medical device sample in the upcoming medical procedure by instructing the distribution module 250 to send the for human use medical device sample to the medical service provider to be inventoried for an upcoming medical procedure. The system 200 may then proceed to step 560 of process 500.

At step 560, the digital samples computing device 110 may communicate with the medical service provider that the medical device sample was utilized and reviewed by the medical professional and has received feedback from the medical professional regarding the medical device sample. The system 200 may then proceed to step 550 of process 500.

At step 550 of process 500, the digital samples computing device 110 may communicate with the medical professional after the medical device sample has been used in the medical procedure to determine how the medical professional would like to proceed regarding the medical sampling device. The medical professional may select from, but is not limited to, the following options: (1) recommend that the medical device manufacturer bring the medical device sample to the hospital committee for approval and/or to engage in contract negotiations with the medical device manufacturer; (2) request additional information regarding the medical device sample from the medical device manufacturer; (3) voice that the medical professional would use the medical device if the medical device were available at the medical service provider but would not request that the medical service provider obtain the medical device; or (4) voice that the medical professional would not use the medical device sample again because the medical device sample did not perform up to the expectations of the medical professional and that the medical professional prefers the existing medical device that the medical professional uses. In response to the medical professional selecting a response, the system 200 may proceed to step 570 of process 500

At step 570 of process 500, the digital samples computing device 110 may communicate back to the medical device manufacturer and/or the hospital procurement manager that the medical device sample was utilized in the medical procedure and reviewed by the medical professional, and that feedback has been received from the medical professional regarding the medical device sample.

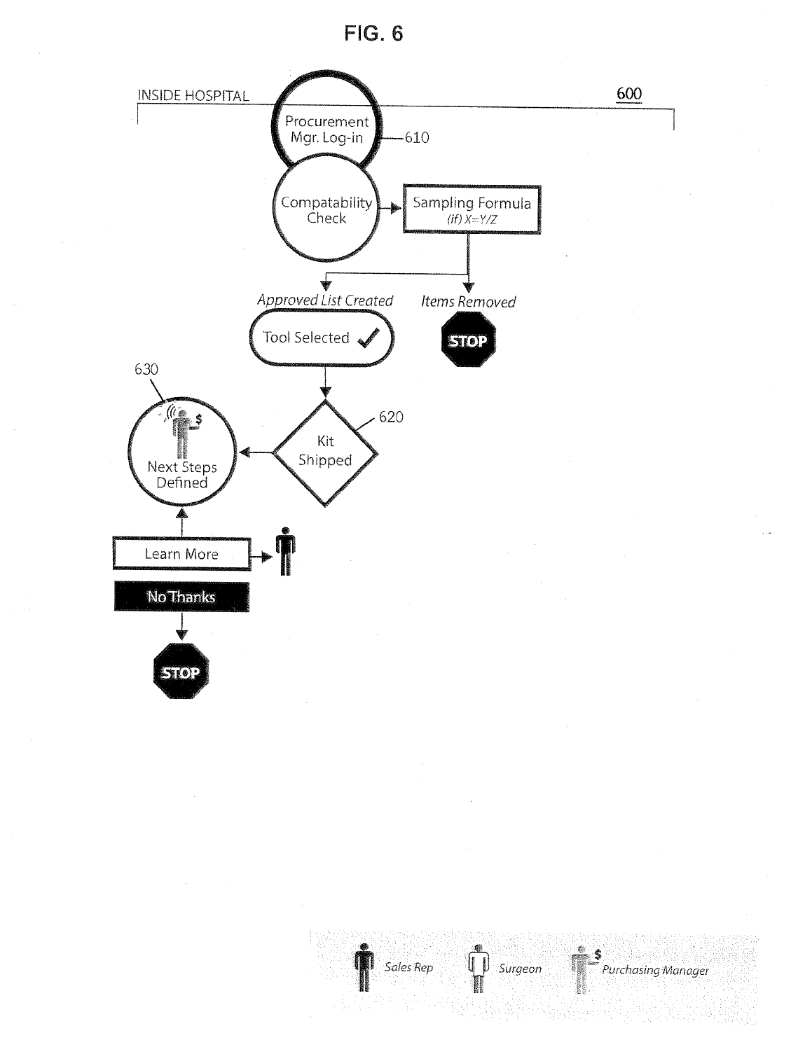

Referring now to FIG. 6, a flowchart is presented showing an exemplary process 600 for handling an on-demand request by a procurement manager of a medical procedure provider that may be executed by the elements of system 200. As shown in FIG. 6, process 600 begins at step 610, when the procurement manager logs into medical device sample inventory viewer included in digital samples computing device 110 and locates a medical device sample that the procurement manager would like to analyze. In response to the medical device sample being located, the system 200 may proceed to step 620 of process 600.

At step 620 of process 600, the digital samples computing device 110 automatically sends the medical device sample to the procurement manager. The medical device sample may be sent as a kit that includes multiple items such as, but not limited to, instructions for use of medical device sample, training materials for the medical device sample and/or other documents. The system 200 may then proceed to step 630 of process 600.

At step 630 of process 600, digital samples computing device 110 may send communication to the procurement manager through a means such as, but not limited to, a text message, e-mail message, voice message, web message and/or application message. This communication may provide the next available steps which may be taken regarding the medical device sample to the medical professional, with the steps being defined by the digital samples computing device 110. The next steps may include, but are not limited to, the procurement manager: (1) indicating a desire to learn more about the medical device sample, or (2) declining to use the device because the procurement manager is not interested in the medical device sample.

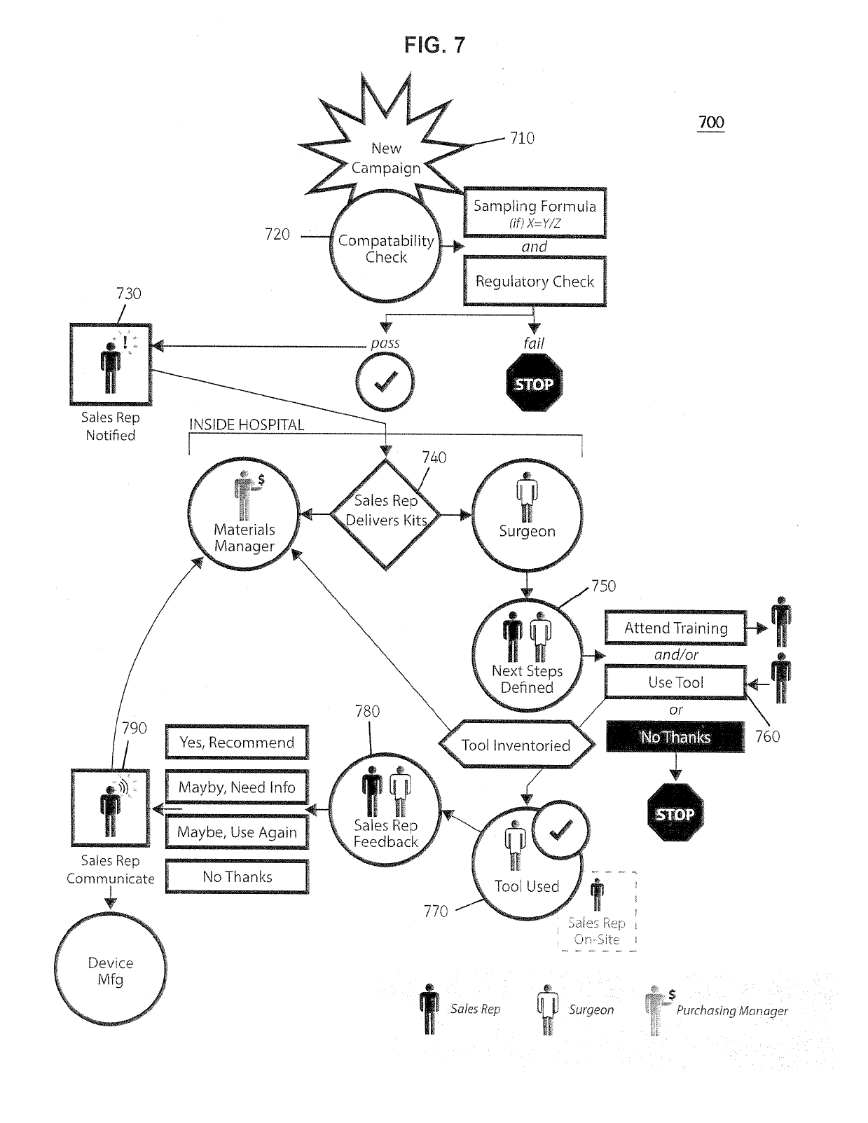

Referring now to FIG. 7, a flowchart is presented showing an exemplary process 700 for manual compatibility matching between a medical device sample and a medical professional that may be executed by elements of system 200. As shown in FIG. 7, process 700 begins at step 710 and in response to a medical device manufacturer initiating a medical device sampling campaign. At step 710 of process 700, the medical device may be added to the digital samples computing device 110 for indexing before proceeding to step 720 of process 700.

At step 720 of process 700, the digital samples computing device 110 may automatically search with searching module 230 the medical device sample inventory database 260 for a medical device sample that matches a scheduled medical procedure. The digital samples computing device 110 may also automatically perform a regulatory compliance check performed by the verification module 270 to determine whether the medical professional scheduled to perform the medical procedure is licensed to use the medical device sample. The digital samples computing device 110 may also automatically by the determination module 290 confirm whether medical service provider is in need of the medical device sample. From step 720, the system 200 may proceed to execute steps 730 and/or 740 of process 700.

At step 730 of process 700, the digital samples computing device 110 may automatically notify a sales representative of a medical device sample that matches a scheduled medical procedure.

At step 740 of process 700, the digital samples computing device 110 may automatically send a kit to the sales representative for the sales representative to hand deliver to the hospital procurement manager. The digital samples computing device 110 may also automatically send a kit to the sales representative for the sales representative to hand deliver to the medical professional. The kit may include various sales and/or marketing materials, and a document informing the hospital procurement manager that the medical professional is evaluating the new medical device sample.

At step 750 of process 700, the sales representative may visit the medical professional to review the medical sample and define the next steps to be taken regarding the medical device sample with the medical professional. The next steps may include, but are not limited to, determining whether the medical professional desires to attend training with the medical device sample in a simulated lab environment, to use the medical device sample in an upcoming medical procedure on a patient, and/or decline the next steps because the medical professional is not interested in the medical device sample. In response to the medical professional indicating a desire to use the medical device, the system 200 may proceed to step 760 of process 700.

At step 760 of process 700, the sales representative acts upon the response provided by the medical professional indicating that the medical professional desires to use the medical device sample in the upcoming medical procedure. In response, the sales representative may hand deliver the for human use medical device sample to the medical professional for an upcoming medical procedure. The system 200 may then proceed to step 770 of process 700.

At step 770 of process 700, the medical device sample is used to perform the procedure. In response, system 200 may proceed to step 780 of process 700. At step 780 of process 700, the sales representative may update system 200 with feedback provided by the medical professional regarding the medical device sample. The sales representative may communicate with the medical professional after the medical device sample has been used in the medical procedure to determine how the medical professional would like to proceed regarding the medical sampling device.

To this end, the medical professional may select from, but is not limited to, the following choices: (1) recommend that the medical device manufacturer bring the medical device sample to the hospital committee for approval and/or to engage in contract negotiations with the medical device manufacturer; (2) request additional information regarding the medical device sample from the medical device manufacturer; (3) voice that the medical professional would use the medical device if the medical device were available at the medical service provider, but would not request that the medical service provider obtain the medical device; or (4) voice that the medical professional would not use the medical device sample again because the medical device sample did not perform up to the expectations of the medical professional and that the medical professional prefers the existing medical device that the medical professional uses. The system 200 may then proceed to step 790 of process 700.

At step 790 of process 700, the digital samples computing device 110 may communicate back to the medical device manufacturer and/or the hospital procurement manager that the medical device sample was utilized in the medical procedure and reviewed by the medical professional and has received feedback from the medical professional regarding the medical device sample.

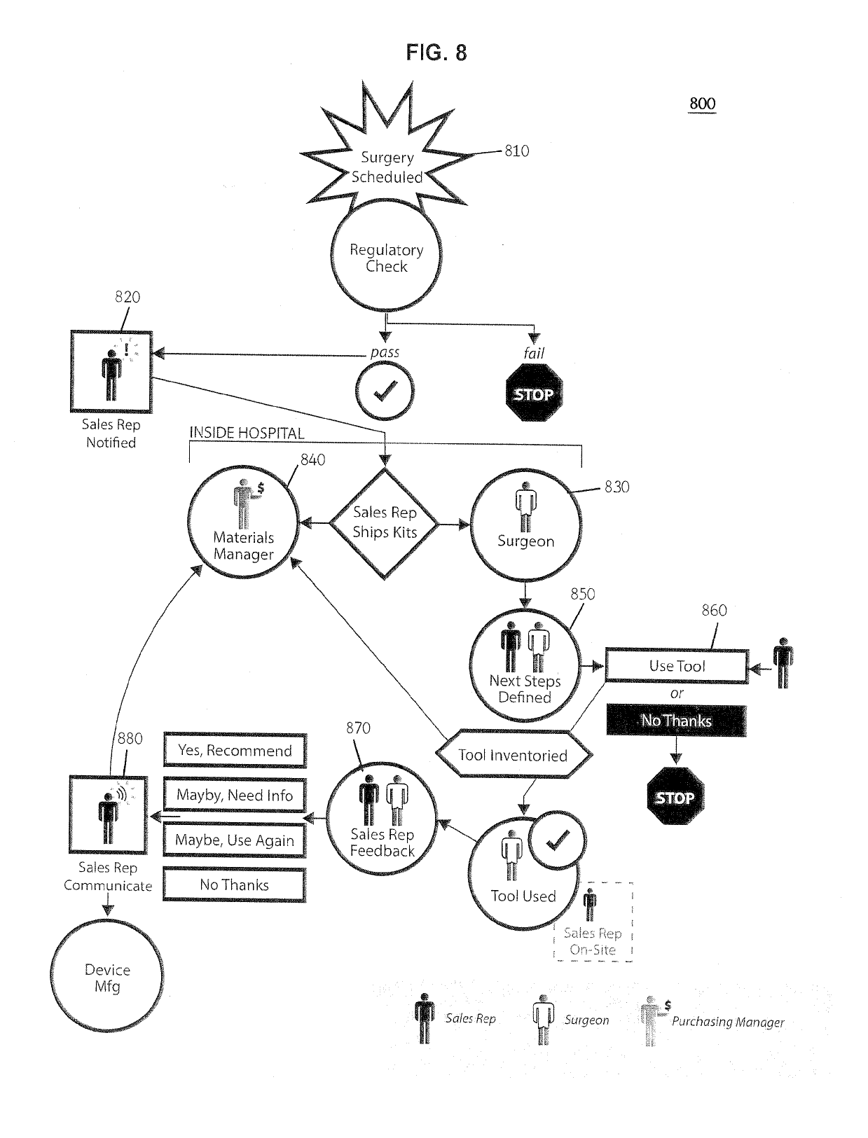

Referring now to FIG. 8, a flowchart is presented showing an exemplary process 800 for manual event matching between a medical device sample and a medical professional that may be executed by the elements of system 200. As shown in FIG. 8, process 800 begins at step 810. At step 810, and in response to a new medical procedure code being published in the medical procedure code database 210 by the hospital information system 130, the system 200 performs a regulatory check. In the present example, the medical procedure code is an ICD-10 procedure code that matches a currently active medical device sampling campaign. The system 200 may then proceed to step 820 of process 800.

At step 820 of process 800, the digital samples computing device 110 may automatically notify a sales representative of a medical device sample that matches a scheduled medical procedure.

At step 830 of process 800, the digital samples computing device 110 automatically sends the medical device sample to the medical professional based upon a regulatory compliance check performed by verification module 270. The medical device sample may be sent as a kit that includes multiple items such as but not limited to instructions for use of medical device sample, training materials for the medical device sample and/or other documents. The system 200 may then proceed to steps 840 and 850 of process 800

At step 840 of process 800, the digital samples computing device 110 may automatically send a kit to the hospital procurement manager that includes various sales and/or marketing material and a document informing the hospital procurement manager that the medical professional is evaluating the new medical device sample.

At step 850 of process 800, the sales representative may in person define the next steps to be taken regarding the medical device sample with the medical professional. The next steps may include, but are not limited to, the medical professional using the medical device sample in an upcoming medical procedure on a patient, and/or declining to use the sample device sample because the medical professional is not interested in the medical device sample. The system may then proceed to step 860 of process 800.

At step 860 of process 800, the sales representative acts upon the response provided by the medical professional in which the medical professional desires to use the medical device sample in the upcoming medical procedure. In response to the medical professional indicating a desire to use the medical device sample, the sales representative may bring in person the medical device sample to the medical service provider for use in an upcoming medical procedure. The system 200 may then proceed to step 870 of process 800.

At step 870 of process 800, the sales representative may update the digital samples computing device 110 with feedback received from the medical professional after the medical device sample has been used in the medical procedure to determine how the medical professional would like to proceed regarding the medical sampling device. The medical professional may proceed may choose from, but is not limited to, the following responses: (1) recommend that the medical device manufacturer bring the medical device sample to the hospital committee for approval and/or to engage in contract negotiations with the medical device manufacturer; (2) request additional information regarding the medical device sample from the medical device manufacturer; (3) voice that the medical professional would use the medical device if the medical device were available at the medical service provider but would not request that the medical service provider obtain the medical device; or (4) voice that the medical professional would not use the medical device sample again because the medical device sample did not perform up to the expectations of the medical professional and that the medical professional prefers the existing medical device that the medical professional uses. In response to receiving the feedback from the medical professional, the system 200 may proceed to step 880 of process 800.

At step 880, the sales representative may communicate back to the medical device manufacturer and/or the hospital procurement manager that the medical device sample was utilized in the medical procedure and reviewed by the medical professional and has received feedback from the medical professional regarding the medical device sample.

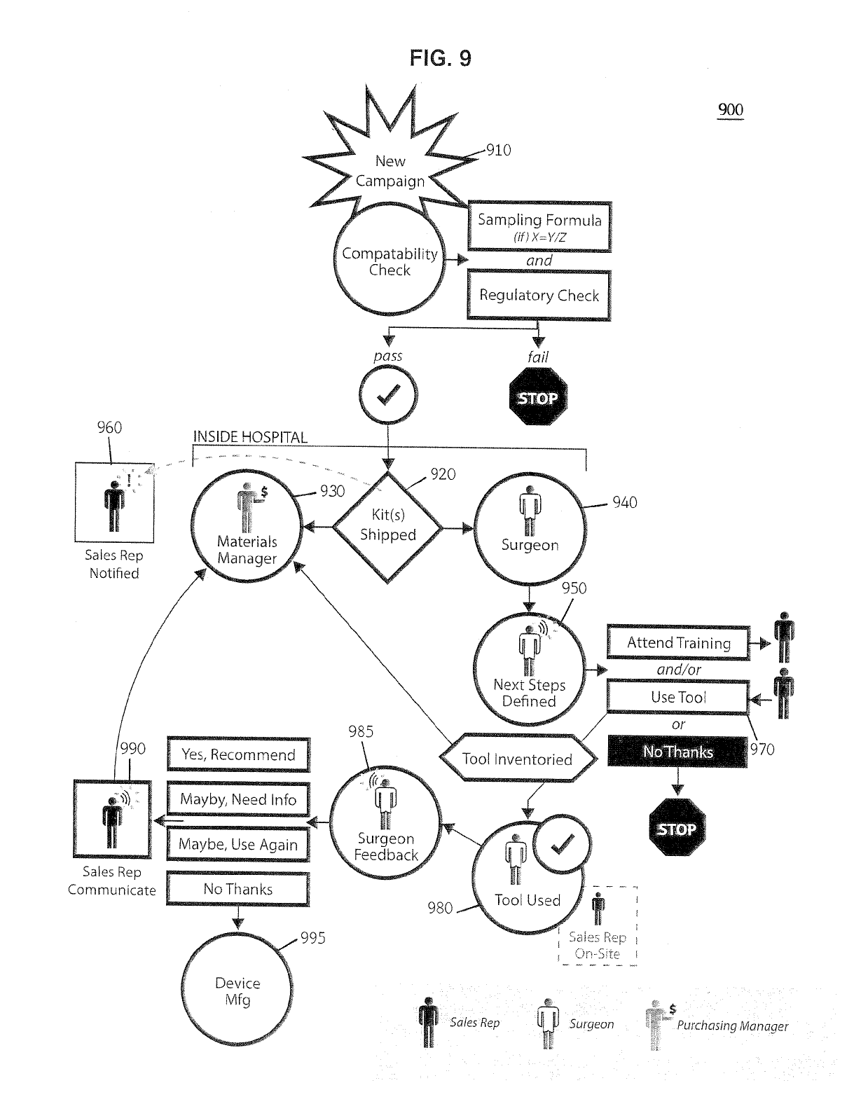

Referring now to FIG. 9, a flowchart is presented showing an exemplary process 900 for semi-automatic compatibility matching between a medical device sample and a medical professional that may be executed by elements of system 200. As shown in FIG. 9, process 900 begins at step 910 and in response to a medical device manufacturer initiating a medical device sampling campaign. At step 910 of process 900, the medical device may be added to the digital samples computing device 110 for indexing before proceeding to step 920 of process 900.

At step 920 of process 900, the digital samples computing device 110 automatically sends the medical device sample to the medical professional based upon a regulatory compliance check performed by the verification module 270. The medical device sample may be sent as a kit that includes multiple items such as, but not limited to, instructions for use of medical device sample, training materials for the medical device sample and/or other documents. From step 920, the system 200 may proceed to execute steps 930 and/or 940 of process 900.

At step 930 of process 900, the digital samples computing device 110 may automatically send a kit to the hospital procurement manager that includes various sales and/or marketing materials, and a document informing the hospital procurement manager that the medical professional is evaluating the new medical device sample.

At step 940 of process 900, the digital samples computing device 110 may send communication to the medical professional through a means such as but not limited to a text message, e-mail message, voice message, web message and/or application message to define the next steps regarding the medical device sample. In response to sending the communication, the system 200 may proceed to step 950 of process 900.

At step 950 of process 900, the digital samples computing device 110 may define the next steps to be taken regarding the medical device sample with the medical professional. The next steps may include, but are not limited to, determining whether the medical professional desires to attend training with the medical device sample in a simulated lab environment, to use the medical device sample in an upcoming medical procedure on a patient, and/or decline the next steps because the medical professional is not interested in the medical device sample. In response to the medical professional indicating a desire to use the medical device, the system 200 may proceed to step 960 of process 900.

At step 960 of process 900, the digital sample computing device 110 communicates to the sales representative of the responses provided by the medical professional regarding the next steps that the medical professional would like to take regarding the medical device sample. The digital sample computing device 110 may also prompt the sales representative to follow-up with both the medical professional and the medical service provider. The system 200 may proceed to step 970 of process 900.

At step 970 of process 900, the sales representative acts upon the response provided by the medical professional indicating that the medical professional desires to use the medical device sample in the upcoming medical procedure. In response, the sales representative may in person deliver the for human use medical device sample to the medical service provider to be used in an upcoming medical procedure. The system 200 may then proceed to step 980 of process 900.

At step 980 of process 900, the medical device sample is used to perform the procedure. In response, system 200 may proceed to step 985 of process 900. At step 985 of process 900, the digital samples computing device 110 may communicate to the medical service provider that the medical device sample was utilized and reviewed by the medical professional and has received feedback from the medical professional regarding the medical device sample. The digital samples computing device 110 may also communicate with the medical professional after the medical device sample has been used in the medical procedure to determine how the medical professional would like to proceed regarding the medical sampling device.

To this end, the medical professional may select from, but is not limited to, the following choices: (1) recommend that the medical device manufacturer bring the medical device sample to the hospital committee for approval and/or to engage in contract negotiations with the medical device manufacturer; (2) request additional information regarding the medical device sample from the medical device manufacturer; (3) voice that the medical professional would use the medical device if the medical device were available at the medical service provider, but would not request that the medical service provider obtain the medical device; or (4) voice that the medical professional would not use the medical device sample again because the medical device sample did not perform up to the expectations of the medical professional and that the medical professional prefers the existing medical device that the medical professional uses. The system 200 may then proceed to step 985 of process 900.

At step 990 of process 900, the sales representative may communicate back to the hospital procurement manager that the medical device sample was utilized in the medical procedure and reviewed by the medical professional and has received feedback from the medical professional regarding the medical device sample. The system 200 may then proceed to step 995 of process 900.

At step 995 of process 900, the digital samples computing device 110 may communicate back to the medical device manufacturer that the medical device sample was utilized in the medical procedure and reviewed by the medical professional and has received feedback from the medical professional regarding the medical device sample.

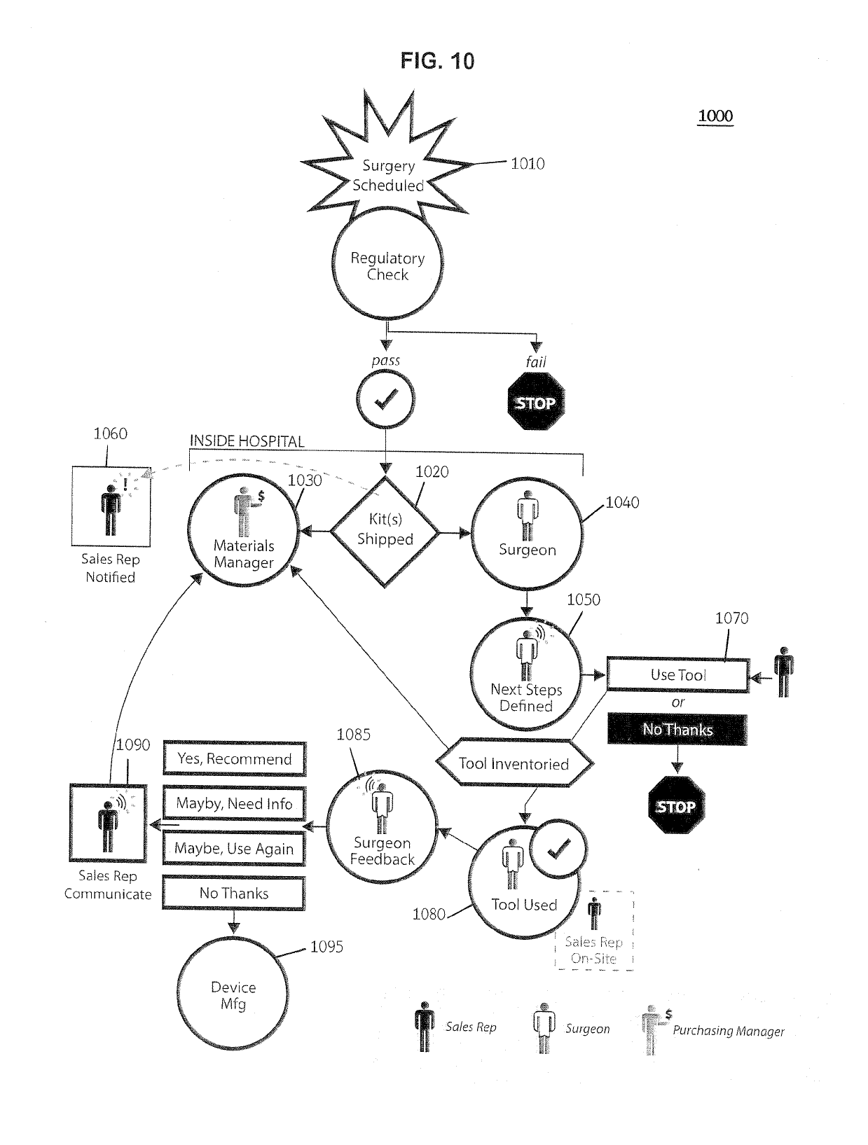

Referring now to FIG. 10, a flowchart is presented showing an exemplary process 1000 for semi-automatic event matching between a medical device sample and a medical professional that may be executed by the elements of system 200. As shown in FIG. 10, process 1000 begins at step 1010. At step 1010, and in response to a new medical procedure code being published in the medical procedure code database 210 by the hospital information system 130, the system 200 performs a regulatory check. In the present example, the medical procedure code is an ICD-10 procedure code that matches a currently active medical device sampling campaign. The system 200 may then proceed to step 1020 of process 1000.

At step 1020 of process 1000, the digital samples computing device 110 automatically sends the medical device sample to the medical professional based upon a regulatory compliance check performed by verification module 270. The medical device sample may be sent as a kit that includes multiple items such as but not limited to instructions for use of medical device sample, training materials for the medical device sample and/or other documents. The system 200 may then proceed to steps 1030 and 1040 of process 1000

At step 1030 of process 1000, the digital samples computing device 110 may automatically send a kit to the hospital procurement manager that includes various sales and/or marketing material and a document informing the hospital procurement manager that the medical professional is evaluating the new medical device sample.

At step 1040 of process 1000, digital samples computing device 110 may send communication to the medical professional through a means such as, but not limited to, a text message, e-mail message, voice message, web message and/or application message to define the next steps regarding the medical device sample. The system 200 may then proceed to step 1050 of process 1000.

At step 1050 of process 1000, the digital samples computing device 110 may define the next steps to be taken regarding the medical device sample with the medical professional. The next steps may include, but are not limited to, the medical professional using of the medical device sample in an upcoming medical procedure on a patient, and/or declining to use the sample device sample because the medical professional is not interested in the medical device sample. The system may then proceed to step 1060 of process 1000.

At step 1060 of process 1000, the digital sample computing device 110 communicates to the sales representative of the responses provided by the medical professional regarding the next steps that the medical professional would like to take regarding the medical device sample. The digital sample computing device 110 may also prompt the sales representative to follow-up with both the medical professional and the medical service provider. The system 200 may proceed to step 1070 of process 1000.

At step 1070 of process 1000, the digital sample computing device 110 acts upon the response provided by the medical professional in which the medical professional desires to use the medical device sample in the upcoming medical procedure. In response to the medical professional indicating a desire to use the medical device sample, the distribution module 250 may send the medical device sample to the medical service provider to be inventoried for an upcoming medical procedure. The system 200 may then proceed to step 1080 of process 1000.

At step 1080 of process 1000, the medical device sample is used to perform the procedure. In response, system 200 may proceed to step 1085 of process 1000.

At step 1085 of process 1000, the digital samples computing device 110 may communicate with the medical professional after the medical device sample has been used in the medical procedure to determine how the medical professional would like to proceed regarding the medical sampling device. The medical professional may choose from, but is not limited to, the following responses: (1) recommend that the medical device manufacturer bring the medical device sample to the hospital committee for approval and/or to engage in contract negotiations with the medical device manufacturer; (2) request additional information regarding the medical device sample from the medical device manufacturer; (3) voice that the medical professional would use the medical device if the medical device were available at the medical service provider but would not request that the medical service provider obtain the medical device; or (4) voice that the medical professional would not use the medical device sample again because the medical device sample did not perform up to the expectations of the medical professional and that the medical professional prefers the existing medical device that the medical professional uses. In response to receiving the feedback from the medical professional, the system 200 may proceed to step 1090 of process 1000.

At step 1090 of process 1000, the sales representative may communicate back to the hospital procurement manager that the medical device sample was utilized in the medical procedure and reviewed by the medical professional and has received feedback from the medical professional regarding the medical device sample. The system 200 may then proceed to step 1095 of process 1000.

At step 1095, digital samples computing device 110 may communicate back to the medical device manufacturer that the medical device sample was utilized in the medical procedure and reviewed by the medical professional and has received feedback from the medical professional regarding the medical device sample.

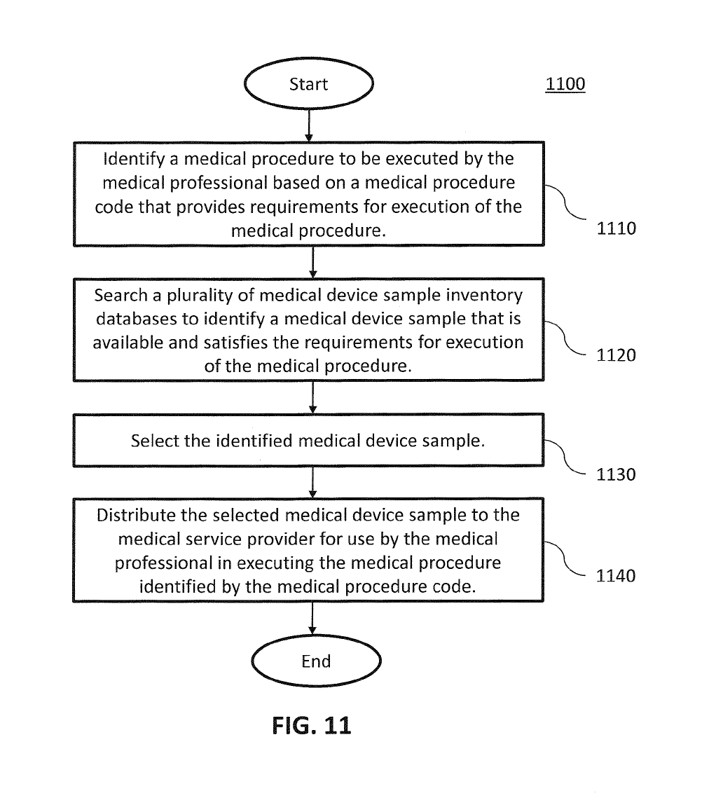

Referring now to FIG. 11, a flowchart is presented showing an exemplary process 1100 for providing a medical device sample. As shown in FIG. 11, process 1100 begins at step 1110, when a medical procedure to be executed by the medical professional is identified based on a medical procedure code that provides requirements for execution of the medical procedure. For example, as shown in FIG. 2, the identification module 220 may identify a medical procedure to be executed by the medical professional. This identification may be based on a medical procedure code stored in medical procedure code database 210, which may provide the requirements for execution of the medical procedure. In response to receiving the medical procedure code, the system 200 may proceed to step 1120 of process 1100.

At step 1120 of process 1100, a plurality of medical device sample inventory databases is searched to identify a medical device sample that is available and satisfies the requirements for execution of the medical procedure. For example, as shown in FIG. 2, the searching module 230 searches medical device sample inventory database 260 to identify a medical device sample that is available and satisfies the requirements for execution of the medical procedure. The system 200 may then proceed to step 1130 of process 1100.

At step 1130 of process 1100, the identified medical device sample is selected. For example, the selection module 240 may select a medical device sample identified by the searching module 230. The system 200 may then proceed to step 1140 of process 1100.

At step 1140 of process 1100, the selected medical device sample is distributed to the medical service provider for use by the medical professional in executing the medical procedure identified by the medical procedure code. For example, the distribution module 250 may distribute the medical device sample selected by selection module 240 to the medical service provider for use by the medical professional in executing the medical procedure identified by the medical procedure code.

Embodiments can work with software, hardware, and/or operating system implementations other than those described herein. Indeed, given the nearly endless hardware and software configurations possible for implementing the modules, processes, and steps described herein, persons having ordinary skill in the art will understand that embodiments of the invention may include any software, hardware, and operating system implementations configured to perform said modules, processes, steps, and/or any other functions set forth herein. Moreover, embodiments of the present invention are applicable to a client, a server, and/or combinations of both.

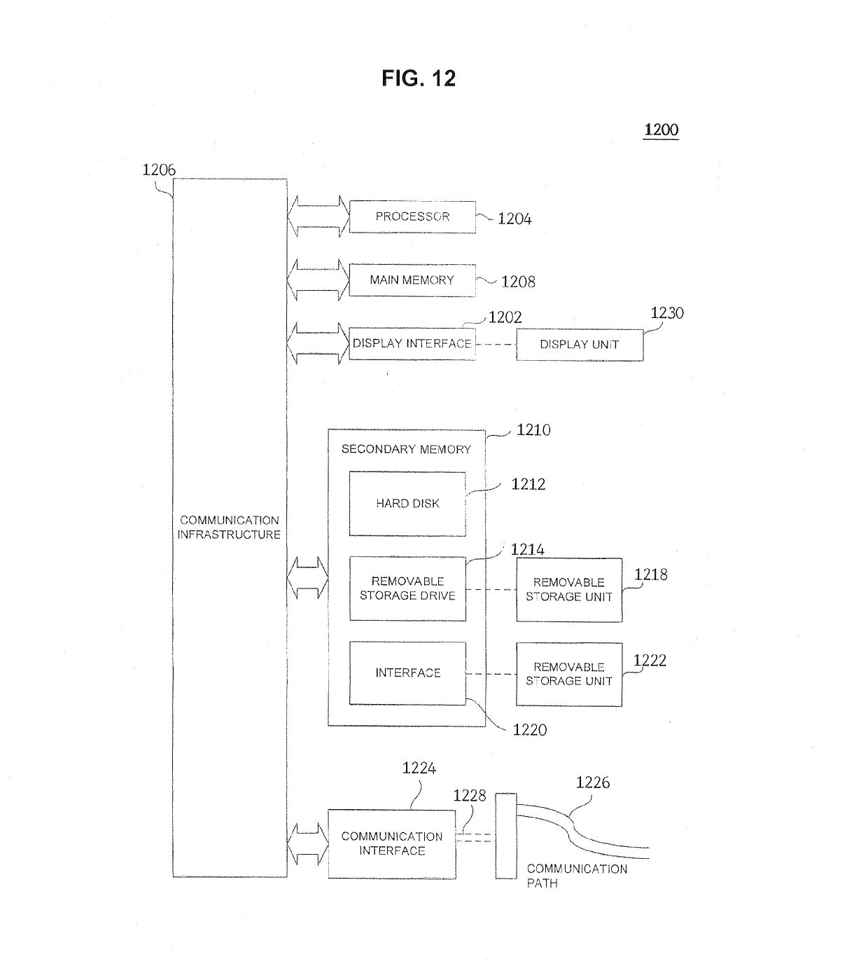

Referring now to FIG. 12, an exemplary computer system 1200 is illustrated in which embodiments of the present invention, or portions thereof, may be implemented as computer-readable code. For example, the digital samples computing device 110 may be implemented on computer system 1200 using hardware, software, firmware, tangible computer readable media having instructions stored thereon, including non-transitory computer media, or a combination thereof. The digital samples computing device 110 may also be implemented in one or more computer systems or other processing system.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

Various embodiments of the invention are described in terms of this example computer system 1200. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons skilled in the relevant art, a computing device having at least one processor device, such as processor device 1204, where the processor device may be a single processor, a plurality of processors, a processor in a multi-core/multiprocessor system, such system operating alone, or in a cluster of computing devices operating in a cluster or server farm. Processor device 1204 is connected to a communication infrastructure 1206, for example, a bus, message queue, network, or multi-core message-passing scheme.

Computer system 1200 also includes a main memory 1208, for example, random access memory (RAM), and may also include a secondary memory 1210. Secondary memory 1210 may include, for example, a hard disk drive 1212, removable storage drive 1214. Removable storage drive 1214 may include a floppy disk drive, a magnetic tape drive, an optical disk drive, a flash memory, or the like. The removable storage drive 1214 reads and/or writes to a removable storage unit 1218 in a well-known manner. Removable storage unit 1218 may include a floppy disk, magnetic tape, optical disk, etc. which is read by and written to by removable storage drive 1214. As will be appreciated by persons skilled in the relevant art, removable storage unit 1218 includes a computer readable storage medium having stored therein computer software and/or data.

In alternative implementations, secondary memory 1210 may include other similar means for allowing computer programs or other instructions to be loaded into computer system 1200. Such means may include, for example, a removable storage unit 1222 and an interface 1220. Examples of such means may include a program cartridge and cartridge interface (such as that found in video game devices), a removable memory chip (such as EPROM, or PROM) and associated socket, and other removable storage units 1222 and interfaces 1220 which allow software and data to be transferred from the removable storage unit 1222 to computer system 1200.

Computer system 1200 may also include a communications interface 1224. Communications interface 1224 allows software and data to be transferred between computer system 1200 and external devices. Communications interfaces 1224 may include a modem, a network interface (such as an Ethernet card), a communications port, a PCMCIA slot and card, a USB port, or the like. Software and data transferred via communications interface 1224 may be in the form of signals, which may be electronic, electromagnetic, optical, or other signals capable of being received by communications interface 1224. These signals may be provided to communications interface 1224 via a communications path 1226.

In this document, the terms “computer program storage medium” and “computer usable storage medium” are used to generally refer to storage media such as removable storage unit 1218, removable storage unit 1222, and a hard disk installed in hard disk drive 1212. Computer program storage medium and computer usable storage medium may also refer to memories, such as main memory 1208 and secondary memory 1210, which may be memory semiconductors (e.g. DRAMS, etc.).

Computer programs (also called computer control logic, computer instructions, software, or program code) are stored in main memory 1208 and/or secondary memory 1210. Computer programs may also be received via communications interface 1224. Such computer programs, when executed, enable computer system 1200 to implement embodiments as discussed herein. In particular, the computer programs, when executed, enable processor device 1204 to implement the processes of the disclosure, such as the steps in the process illustrated by flowchart 1100 of FIG. 11 discussed above. Accordingly, such computer programs represent controllers of the computer system 1200. When an embodiment is implemented using software, the software may be stored in a computer program product and loaded into computer system 1200 using removable storage drive 1214, interface 1220, and hard disk drive 1212, or communications interface 1224.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details of the representative apparatus and method, and illustrative examples shown and described. Accordingly, departures may be made from such details without departing from the spirit or scope of applicants' general inventive concept.

What is claimed is:

1. A computer implemented method for providing a medical device sample to a medical professional, comprising:
identifying a medical procedure to be executed by the medical professional based on a medical procedure code that provides requirements for execution of the medical procedure;
searching at least one medical device sample inventory database to identify a medical device sample that is suitable for execution of the medical procedure; and
arranging for distribution of the identified medical device sample to the medical professional for use in executing the medical procedure identified by the medical procedure code.

2. The computer implemented method of claim 1, further comprising:
verifying that the medical professional satisfies qualification criteria that qualifies the medical professional to use the identified medical device sample.

3. The computer implemented method of claim 1, further comprising:
analyzing retention of the identified medical device sample by the medical professional for additional medical procedures following usage of the identified medical device sample in the execution of the initial medical procedure.

4. The computer implemented method of claim 1, further comprising:
determining whether medical device samples substantially equivalent to the identified medical device sample have been previously distributed to the medical service provider for use by medical professionals.

5. The computer implemented method of claim 1, wherein the identifying step comprises:
identifying a plurality of medical procedure codes, wherein each identified medical procedure code includes requirements that require medical devices that are replaceable with medical device samples for execution of the medical procedure referenced by each defined medical procedure code; and
receiving the defined plurality of medical procedure codes from the hospital information system.

6. The computer implemented method of claim 1, wherein the searching step comprises:
identifying a plurality of medical device sample codes, wherein each medical device sample available for sampling is associated with the medical device sample code that identifies the medical device sample; and
matching a selected medical device sample code that identifies the identified medical device sample that satisfies the requirements provided by the medical procedure code with the medical procedure code.

7. The computer implemented method of claim 1, further comprising:
receiving an updated medical device preference card for the medical professional that executed the medical procedure with the identified medical device sample, wherein the updated medical device preference card provides a list of preferred medical devices for the medical professional in executing the medical procedure.

8. A system for identifying a medical device sample to be provided to a medical professional, the system comprising:
an identification module configured to identify the medical procedure to be executed by the medical professional based on a medical procedure code that provides requirements for execution of the medical procedure;
a search module configured to search at least one medical device sample inventory database to identify a medical device sample that is suitable for execution of the medical procedure; and
a distribution module configured to arrange for distribution of the identified medical device sample to the medical professional for use in executing the medical procedure identified by the medical procedure code.

9. The system of claim 8, further comprising:
a verification module configured to verify that the medical professional satisfies qualification criteria that qualifies the medical professional to use the selected medical device sample.

10. The system of claim 8, further comprising:
an analysis module configured to analyze retention of the identified medical device sample by the medical professional for additional medical procedures following usage of the identified medical device sample in the execution of the initial medical procedure.

11. The system of claim 8, further comprising:
a determination module configured to determine whether medical device samples substantially equivalent to the identified medical device sample have been previously distributed to the medical service provider for use by medical professionals.

12. The system of claim 8, wherein the identification module is further configured to:
identify a plurality of medical procedure codes, wherein each identified medical procedure code includes requirements that require medical devices that are replaceable with medical device samples for execution of the medical procedure referenced by each defined medical procedure code; and
receive the defined plurality of medical procedure codes from a hospital information system.

13. The system of claim 8, wherein the searching module is further configured to:
identify a plurality of medical device sample codes, wherein each medical device sample available for sampling is associated with the medical device sample code that identifies the medical device sample; and
match a selected medical device sample code that identifies the identified medical device sample that satisfies the requirements provided by the medical procedure code with the medical procedure code.

14. The system of claim 8, further comprising:
a receiving module configured to receive an updated medical device preference card for the medical professional that executed the medical procedure with the identified medical device sample, wherein the updated medical device preference card provides a list of preferred medical devices for the medical professional in executing the medical procedure.

15. A computer readable storage medium encoded with a computer program, the program comprising instructions that when executed by one or more processors cause the one or more processors to perform operations comprising:
identifying a medical procedure to be executed by a medical professional based on a medical procedure code that provides requirements for execution of the medical procedure;
searching at least one medical device sample inventory database to identify a medical device sample that is suitable for execution of the medical procedure; and
arranging for distribution of the identified medical device sample to the medical professional for use in executing the medical procedure identified by the medical procedure code.

16. The computer readable storage medium of claim 15, further comprising:
verifying that the medical professional satisfies qualification criteria that qualifies the medical professional to use the identified medical device sample.

17. The computer readable storage medium of claim 15, further comprising:
analyzing retention of the selected medical device sample by the medical professional for additional medical procedures following usage of the identified medical device sample in the execution of the initial medical procedure.

18. The computer readable storage medium of claim 15, further comprising:
determining whether medical device samples are substantially equivalent to the identified medical device sample that have been previously distributed to the medical service provider for use by medical professionals.

19. The computer readable storage medium of claim 15, wherein the identifying step further comprises:
identifying a plurality of medical procedure codes, wherein each identified medical procedure code includes requirements that require medical devices that are replaceable with medical device samples for execution of the medical procedure referenced by each defined medical procedure code; and
receiving the defined plurality of medical procedure codes from a hospital information system.

20. The computer readable storage medium of claim 15, wherein the searching step comprises:
identifying a plurality of medical device sample codes, wherein each medical device sample available for sampling is associated with the medical device sample code that identifies the medical device sample; and
matching a selected medical device sample code that identifies the identified medical device sample that satisfies the requirements provided by the medical procedure code with the medical procedure code.

21. A computer implemented method for providing a medical device sample to a medical professional, comprising:
identifying a medical procedure code to be executed by the medical professional based on a medical procedure code that provides requirements for execution of the medical procedure;
searching at least one medical device sample inventory database to identify a medical device sample that is suitable for execution of the medical procedure;
notifying an individual that the medical device sample is identified as being suitable for execution of the medical procedure; and
arranging for distribution of the identified medical device sample to at least one of the individual and/or the medical professional for use by the medical professional in executing the medical procedure identified by the medical procedure code.

22. The computer implemented method of claim 21, further comprising:
verifying that the medical professional satisfies qualification criteria that qualifies the medical professional to use the identified medical device sample.

23. The computer implemented method of claim 21, further comprising:
determining whether medical device samples substantially equivalent to the identified medical device sample have been previously distributed to the sales representative for use by medical professionals.

24. The computer implemented method of claim 21, wherein the identifying step comprises:
identifying a plurality of medical procedure codes, wherein each identified medical procedure code includes requirements that require medical devices that are replaceable with medical device samples for execution of the medical procedure referenced by each defined medical procedure code; and
receiving the defined plurality of medical procedure codes from the hospital information system.

25. The computer implemented method of claim 21, wherein the searching step comprises:
identifying a plurality of medical device sample codes, wherein each medical device sample available for sampling is associated with the medical device sample code that identifies the medical device sample; and
matching a selected medical device sample code that identifies the identified medical device sample that satisfies the requirements provided by the medical procedure code with the medical procedure code.

26. A system for providing a medical device sample to a medical professional, comprising:
an identification module configured to identify a medical procedure to be executed by the medical professional based on a medical procedure code that provides requirements for execution of the medical procedure;
a searching module configured to search at least one medical device sample inventory database to identify a medical device sample that is suitable for execution of the medical procedure;
a notification module configured to notify an individual that the medical device sample is identified as being suitable for execution of the medical procedure; and
a distribution module configured to arrange for distribution of the identified medical device sample to at least one of the individual and/or the medical professional for use by the medical professional in executing the medical procedure identified by the medical procedure code.

27. The system of claim 26, further comprising:
a verification module configured to verify that the medical professional satisfies qualification criteria that qualifies the medical professional to use the identified medical device sample.

28. The system of claim 26, further comprising:
a determination module configured to determine whether medical device samples substantially equivalent to the identified medical device sample have been previously distributed to the sales representative for use by medical professionals.

29. The system of claim 26, wherein the identification module is further configured to:
identify a plurality of medical procedure codes, wherein each identified medical procedure code includes requirements that require medical devices that are replaceable with medical device samples for execution of the medical procedure referenced by each defined medical procedure code; and
receiving the defined plurality of medical procedure codes from the hospital information system.

30. The system of claim 26, wherein the searching module is further configured to:
identify a plurality of medical device sample codes, wherein each medical device sample available for sampling is associated with the medical device sample code that identifies the medical device sample; and
matching a selected medical device sample code that identifies the identified medical device sample that satisfies the requirements provided by the medical procedure code with the medical procedure code.

31. A computer readable storage medium encoded with a computer program, the program comprising instructions that when executed by one or more processors cause the one or more processors to perform operations comprising:
identifying a medical procedure code to be executed by a medical professional based on a medical procedure code that provides requirements for execution of the medical procedure;
searching at least one medical device sample inventory database to identify a medical device sample that is suitable for execution of the medical procedure;
notifying an individual that the medical device sample is identified as being suitable for execution of the medical procedure; and
arranging for distribution of the identified medical device sample to at least one of the individual and/or the medical professional for use by the medical professional in executing the medical procedure identified by the medical procedure code.

32. The computer readable storage medium of claim 31, further comprising:
verifying that the medical professional satisfies qualification criteria that qualifies the medical professional to use the identified medical device sample.

33. The computer readable storage medium of claim 31, further comprising:
determining whether medical device samples substantially equivalent to the identified medical device sample have been previously distributed to the sales representative for use by medical professionals.

34. The computer readable storage medium of claim 31, wherein the identifying step comprises:
identifying a plurality of medical procedure codes, wherein each identified medical procedure code includes requirements that require medical devices that are replaceable with medical device samples for execution of the medical procedure referenced by each defined medical procedure code; and
receiving the defined plurality of medical procedure codes from the hospital information system.

35. The computer readable storage medium of claim 31, wherein the searching step comprises:
identifying a plurality of medical device sample codes, wherein each medical device sample available for sampling is associated with the medical device sample code that identifies the medical device sample; and
matching a selected medical device sample code that identifies the identified medical device sample that satisfies the requirements provided by the medical procedure code with the medical procedure code.
